(19) United States
(12) Patent Application Publication
(10) Pub. No.: US 2020/0356565 A1
(43) Pub. Date: Nov. 12, 2020

(54) SYSTEM AND METHOD FOR LIVE ONLINE CONSULTATION

(71) Applicant: Mindshare Technologies Incorporated, Ottawa (CA)

(72) Inventor: John Stewart, Carp (CA)

(21) Appl. No.: 16/464,596

(22) PCT Filed: Nov. 28, 2017
(86) PCT No.: PCT/CA2017/051429

§ 371 Date: May 28, 2019

Related U.S. Application Data
(60) Provisional application No. 62/427,030, filed on Nov. 28, 2016.
(60) Provisional application No. 62/487,968, filed on Apr. 20, 2017.

(51) Int. Cl. G06F 16/2455; G06F 16/248

(52) U.S. Cl. CPC G06F 16/24553; G06F 16/248

(57) ABSTRACT

Systems, methods, and devices relating to the facilitation of interactions between consumer users and supplier users. Consumer users with a need for specialized expertise enter a query on their computing device. This query is communicated to a server which searches its database for supplier users who have specialized expertise which may address the consumer user's query. A list of such supplier users is compiled by the server and this list is sent to the consumer user. The consumer user then selects one or more of these supplier users and the server activates one or more communications modules which allows the consumer user to interact with the selected supplier user. The interaction between the consumer user and the supplier user is timed by the server and the length of the interaction is stored and reported to both users.

### TECHNICAL FIELD

The present invention relates to computer systems and computer systems connected to large networks. More specifically, the present invention relates to computer systems having an intelligent search engine that facilitates interactions and connections between users who have need of specialized expertise and subject matter expert (SME) users who have such specialized expertise.

### BACKGROUND

The necessity for special expertise is something that everyone is familiar with. Whether it is solving a high school or university level math question, renovating a backyard deck, or even barbecuing pork ribs, everyone has, at one time or another, wished they could avail of someone with expertise, knowledge, or experience in a particular field. Instead of costly trial and error, a specific question to a person with specialized expertise can solve problems that a person may have encountered in a particular endeavor. As an example, to cook the perfect pork ribs, should the ribs be parboiled before being grilled? Also, is a charcoal grill better for the ribs or would broiling them in an oven suffice? A layperson seeking answers to such questions, in the part, would need to consult multiple books, sources, and, in the end, might simply need resort to trial and error for a suitable answer.

The Internet and its myriad websites have, to a certain extent, addressed this need for expertise. There are now specialized websites and web content dedicated to everything from solving specific math problems to various cooking techniques and everything in between. However, such specialized knowledge only comes after a lot of effort on a user's part. Returning to our barbecuing example, a person wishing to barbecue or cook some pork ribs might need to consult multiple specialized websites and view multiple videos, multimedia presentations, and read literature from equipment suppliers. And, even after all that, there is no guarantee that such involved research will result in a suitable answer to the person's query. Such a suitable answer may lie buried in an obscure website that the person may not even consult.

Another major drawback to the current method of researching such specialized topics is that laypeople cannot help but apply a scattershot approach to finding answers. Entering a search query in a search engine might help but receiving pertinent and relevant search results can be based mostly on whether a proper query was entered and on whether the search engine has properly indexed the relevant websites. The person's query might be quickly answered by a subject matter expert or by someone with expertise on the subject but finding such a person, either online or in person, might also be quite difficult. Again, searching by using search engines may provide the names of subject matter experts but there is no guarantee that such experts are willing or even available to answer queries from the general public.

Clearly, a better way to access specialized expertise or a better way to find people with such specialized expertise is needed. The present invention seeks to address the shortcomings of the prior art by mitigating if not overcoming such shortcomings.

### SUMMARY

The present invention provides systems, methods, and devices relating to the facilitation of interactions between consumer users and supplier users. Consumer users with a need for specialized expertise enter a query on their computing device. This query is communicated to a server that searches its database for supplier users who have specialized expertise that may address the consumer user's query. A list of such supplier users is compiled by the server and this list is sent to the consumer user. The consumer user then selects one or more of these supplier users and the server activates one or more communications modules that allows the consumer user to interact with the selected supplier user. The interaction between the consumer user and the supplier user is timed by the server and the length of the interaction is stored and reported to both users.

In a first aspect, the present invention provides a system for facilitating online interactions between at least one consumer user and at least one supplier user, the system comprising:
a server comprising:
   a supplier database, said supplier database containing a plurality of supplier profiles for a plurality of supplier users, each of said supplier profiles detailing at least one specific expertise of a specific supplier user, and a plurality of expertise keywords relating to said at least one specific expertise;
   a plurality of communications modules, each of said plurality of communications modules being for facilitating direct online communications between at least one consumer user and one of said plurality of supplier users;
      and
at least one processor for:
   receiving a query from said at least one consumer user;
   determining, based on said query, query keywords for expertise relating to said query;
   searching said database for at least one supplier user whose at least one specific expertise relates to said query keywords;
   retrieving supplier user profiles based on said query for said at least one supplier profile whose at least one specific expertise relates to said query keywords;
   presenting supplier user profiles retrieved based on said query, said supplier profiles retrieved being presented to said at least one consumer user;
   receiving input from said at least one consumer user selecting one of said supplier profiles presented, said input indicating a selected supplier user;
   activating at least one of said plurality of communications modules to send and receive data from said selected supplier user and sending data received from said selected supplier user to said at least one consumer user to thereby allow for an interaction between said selected supplier user and said at least one consumer user;
   deactivating said at least one of said plurality of communications modules when said interaction is terminated;
   determining a duration for said interaction.

In a second aspect, the present invention provides a system for online interactions between a consumer user and a supplier user, the system comprising:
a server;
a database containing profiles;
a processor;

wherein
said system receives a query from said consumer user;
based on said query, said processor searches said database for at least one supplier user whose at least one specific expertise relates to said query;
said system activates at least one communications module such that said consumer user and said at least one supplier user are in online communications with each other to discuss said query;
said system determines a duration for an interaction between said consumer user and said supplier user using said at least one communications module.

In a third aspect, the present invention provides a method for facilitating interactions between a consumer user and a supplier user, the method comprising:

a) receiving a query from said consumer user regarding a specific topic;

b) searching a database for profiles of supplier users who have expertise in said specific topic;

c) compiling a list of supplier users who have said expertise in said specific topic;

d) sending said list to said consumer user;

e) receiving an indication of a selected supplier user from said consumer user, said selected consumer user being selected from said list;

f) receiving a request from said consumer user for interaction with said selected supplier user;

g) activating at least one communications module to allow said consumer user to communicate and interact with said selected supplier user.

In a fourth aspect, the present invention provides a system for facilitating online interactions between at least one consumer user and at least one supplier user, the system comprising:
a server comprising:
   a supplier database, said supplier database containing a plurality of supplier profiles for a plurality of supplier users, each of said supplier profiles detailing at least one specific expertise of a specific supplier user, and a plurality of expertise keywords relating to said at least one specific expertise;
   a plurality of communications modules, each of said plurality of communications modules being for facilitating direct online communications between at least one consumer user and one of said plurality of supplier users;
   and
at least one processor for:
   receiving a query from said at least one consumer user;
   determining, based on said query, query keywords for expertise relating to said query;
   searching said database for at least one supplier user whose at least one specific expertise relates to said query keywords;
   retrieving supplier user profiles based on said query for said at least one supplier profile whose at least one specific expertise relates to said query keywords;
   presenting supplier user profiles retrieved based on said query, said supplier profiles retrieved being presented to said at least one consumer user;
   receiving input from said at least one consumer user selecting one of said supplier profiles presented, said input indicating a selected supplier user;
   activating at least one of said plurality of communications modules to send and receive data from said selected supplier user and sending data received from said selected supplier user to said at least one consumer user to thereby allow for an interaction between said selected supplier user and said at least one consumer user; and
   deactivating said at least one of said plurality of communications modules when said interaction is terminated.

According to a fifth aspect, the present invention provides a system for providing expertise from a supplier user to a consumer user seeking said expertise, the system comprising:
a query module for receiving a query regarding said expertise from said consumer user;
a search module for searching for at least one supplier user having said expertise;
a communications module for facilitating online communications between said consumer user and said at least one supplier user with said expertise;

wherein
said communications module is activated only after said search module has found said at least one supplier user having said expertise.

In a sixth aspect, the present invention provides a method for providing expertise from a supplier user to a consumer user seeking said expertise, the method comprising:
receiving a query from said consumer user, said query regarding said expertise;
searching for at least one supplier user having said expertise;
once said at least one supplier user having said expertise has been found, initiating an online communication between said consumer user and said at least one supplier user.

According to a seventh aspect, the present invention provides computer readable media having encoded thereon computer readable and computer executable instructions which, when executed by a processor, implements a method for providing expertise from a supplier user to a consumer user seeking said expertise, the method comprising:
receiving a query from said consumer user, said query regarding said expertise;
searching for at least one supplier user having said expertise;
once said at least one supplier user having said expertise has been found, initiating an online communication between said consumer user and said at least one supplier user.

In another aspect, the present invention provides computer readable media having encoded thereon computer readable and computer executable instructions that, when executed by a processor, implements a method for facilitating interactions between a consumer user and a supplier user, the method comprising:

a) receiving a query from a consumer data processing device operated said consumer user regarding a specific topic;

b) searching a database for profiles of supplier users who have expertise in said specific topic;

c) compiling a list of supplier users who have said expertise in said specific topic;

d) sending said list to said consumer data processing device;

e) receiving an indication of a selected supplier user from said consumer user's consumer data processing device, said selected consumer user being selected from said list;

f) receiving a request from said consumer data processing device for interaction with said selected supplier user;

g) activating at least one communications module to allow said consumer data processing device to communicate and interact with said selected supplier user by way of a supplier data processing device, said supplier data processing device being operated by said selected supplier user.

According to a further aspect, a user inputs into a computer an unstructured query using a human-machine interface, and keywords are extracted from the inputted unstructured query and compared against one or more of profiles of subject matter experts (SMEs) and optionally historical timed durations of specific types of communications between users and their matched SMEs from relevant keywords. Once a user is connected with an SME based on the inputted query, the types of communications exchanged between the matched user and SME are monitored. When a certain type or types of communications occur between the searcher and a matched SME, the time duration of that communication is logged. Other types of communications are not logged by time duration, so the types of communications are monitored, and only certain types are logged. Optionally, keyword extraction and matching with SMEs from the inputted unstructured queries can be assessed as a function of the time duration of communications among users and SMEs that were matched with relevant keywords. For example, different weights can be applied to time-logged communications as a function of their duration, such that longer logged communications are weighted higher compared to shorter logged communications. Future queries involving the same keywords will thus be more likely to be matched with the same SME, producing higher quality search results that are more directly relevant to the unstructured query. Matching subject matter experts with users starting with an unstructured query enhances the functioning of the computer, by providing increasingly relevant matches by monitoring and logging a time duration when certain types of communications occur between matched users and SMEs. The longer these communications occur, it can be inferred that the original match was a relevant one, so the next time an unstructured query is inputted with the same or similar keywords, the same SME or an SME having the same or similar profile as the previous SME can be connected with the user.

Additional aspects also show various graphical user interfaces for an electronic display screen or portion thereof.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a screenshot of an application that implements one aspect of the invention;

FIG. 2A is an illustration of a generic landing page similar to FIG. 2; FIG. 2A is a front view of a graphical user interface for a display screen or portion thereof showing our new design;

FIG. 3 is a screenshot of supplier users that the system has found in response to a query from a consumer user;

FIG. 3A is an illustration of a results page similar to FIG. 3; FIG. 3A is a front view of a graphical user interface for a display screen or portion thereof showing our new design;

FIG. 4 is a sample supplier user profile as viewed by a consumer user and as selected by a consumer user from the list in FIG. 3;

FIG. 4A is an illustration of generic profile for a supplier user similar to FIG. 4; FIG. 4A is a front view of a graphical user interface for a display screen or portion thereof showing our new design;

FIG. 5 is an interface screen of an audio session or interaction in progress as viewed by a consumer user;

FIG. 6 is an interface screen of a video conference session or interaction in progress as viewed by a consumer user;

FIG. 7 illustrates a session summary screen as viewed by a consumer user for a just completed session;

FIG. 8 is an illustration of a listing of a consumer user's supplier user contacts;

FIG. 8A is an illustration of a generic listing of a consumer user's contacts similar to FIG. 8; FIG. 8A is a front view of a graphical user interface for a display screen or portion thereof showing our new design;

FIG. 9 illustrates a user interface for a timeline tool for a supplier user;

FIG. 10 illustrates a user interface for a text message management tool for a supplier user;

FIG. 11 is a user interface for a profile management tool for a supplier user;

FIG. 12 is a user interface for a calendar management tool for a supplier user;

FIG. 12A is a user interface of a main or initial view of an application according to one aspect of the invention;

FIG. 13 is a block diagram illustrating the steps in a method according to another aspect of the invention;

FIGS. 14-19 illustrate screenshots of user interfaces which may be used to register a consumer user with the system;

FIG. 20-24 illustrate the various screens that a consumer user may view once the consumer user has registered;

FIGS. 25-37 illustrate user interfaces and forms that a supplier user has to complete to register as a supplier user;

FIGS. 38-44 illustrate screens that a supplier user encounters when setting up a video conference call with a consumer user;

FIGS. 45-51 illustrate the various options available to a supplier user during a video conference;

FIGS. 52-53 illustrate feedback and summary screens for a supplier user once a video conference has concluded;

FIGS. 54-58 are screen shots of screens encountered by a consumer user for a video conference with a supplier user including screens for leaving feedback for the supplier user;

FIGS. 59-62 illustrate various search options available to a consumer user when seeking supplier users;

FIGS. 63-94 illustrate screenshots of another implementation of the system where some interfaces are alternatives to interfaces previously presented while other interfaces add functionality to previously presented interfaces; and

FIG. 95 illustrates a block diagram of the various modules of a system which may be used to implement the present invention.

### DETAILED DESCRIPTION

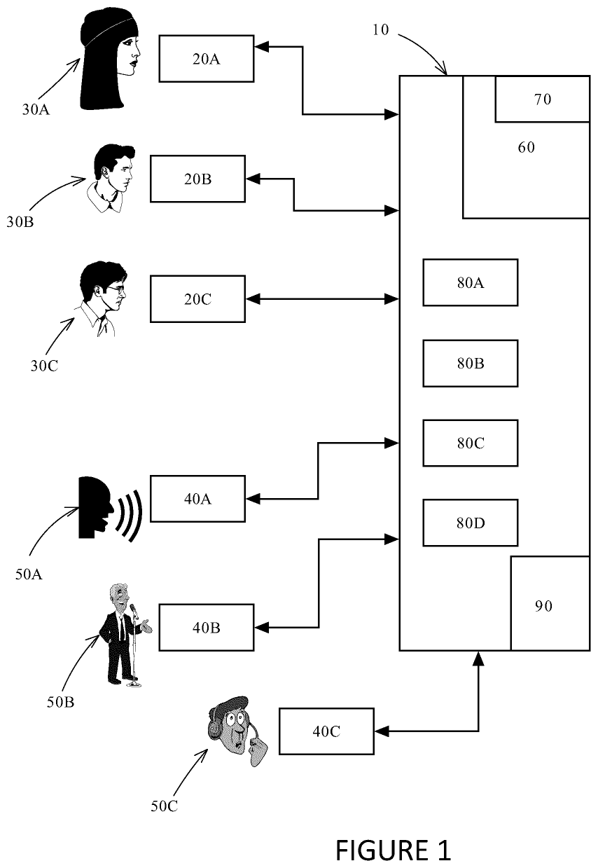

Referring to FIG. 1, a block diagram of a system according to one aspect of the invention is illustrated. A server 10 communicates with devices 20A, 20B, 20C of consumer users 30A, 30B, 30C (respectively) as well as with devices 40A, 40B, 40C of supplier users 50A, 50B, 50C, respectively. For clarity, a consumer user is a user who is seeking a person with specialized expertise or specialized knowledge. A supplier user is a person with such specialized expertise or knowledge. Each of the devices 20A-20C and the devices 40A-40C is a network connected device that is capable of connecting to a wider computer network such as the Internet and may take the form of a mobile computing device (such as a mobile phone, a tablet, or a portable computer) or it may take the form of a more traditional desktop computer or any other device that allows users to connect to network and communicate with other similar devices. Each of the devices 20A-20C and devices 40A-40C may, in addition to the capability of connecting to computer and/or communications networks, have voice communications capabilities, video conference capabilities, still photograph capabilities, video capabilities, touch screen capabilities, and/or stylus input capabilities.

As can be seen, the server 10 includes a database 60 for storing profiles 70. In addition to the database 60, the server 10 also includes communications modules 80A, 80B, 80C, 80D. These communications modules allow consumer users to communicate with the supplier users using a variety of interfaces. As an example, the consumer user 30A may communicate with the supplier user 50A by voice using communications module 80A. Similarly, consumer user 30B may communicate with supplier user 50B using video conferencing by way of communications module 80B. It should be noted that more than one communications module may be active for communications and interactions between a consumer user and a supplier user. As an example, a communications module 80A may be active to allow voice-based interaction between a consumer user and a supplier user. Simultaneously, another communications module 80C may also be active to allow the supplier user to share his screen with the consumer user if the supplier user wishes to show something on his screen to the consumer user. As well, a communications module may also be used to allow for a one-to-many communications. In one example, a supplier user may provide a live video feed of a demonstration and the video feed may be simultaneously accessible to multiple consumer users.

The system operates with the consumer user first entering a query into a website or into an “app” or application using the device 20A. The query may be enhanced by a pull-down list of categories or subcategories of subjects. The query is then communicated to the server 10 and a processor 90 in the server determines what specialized expertise or knowledge is required to respond to the query or which specialized expertise or knowledge relates to the query. The processor then searches the database for profiles of supplier users who have such specialized expertise or knowledge. A listing of such supplier users is compiled and the listing is sent to the consumer user's device. The consumer user then selects one or more of these supplier users to interact with. Once at least one supplier user is selected, the server and the processor then activates at least one of the communications modules to enable interaction between the consumer user and the selected supplier user. This interaction is timed and, once the interaction has ended, the processor then determines how long the interactions lasted. Further metrics regarding the interactions may be calculated by the processor based on the duration of these interactions.

Preferably, the consumer user with the query has an active account with the service provider operating the system of the invention or with a service provider providing the service and which is using the system. Such an account would allow for quicker access to the system. A consumer user can thus sign up with the service provider with a unique username and may, if necessary, place a credit card or some other charge account or bank account or other payment method on file with the service provider and any amounts chargeable to the consumer user would be charged against that payment method. Online payment methods such as that operated under the tradenames PayPal™, Skrill™, Google Wallet™, Payoneer™, and Stripe™ may also be used. It should be noted that, in some implementations, each consumer user creates and populates an online consumer user profile that is stored on the database. Of course, depending on the implementation, each user's billing/financial data may be stored with another service provider such that the system's service provider does not, in actuality, store such sensitive data.

For the supplier user, an account with the same service provider would, of course, be required. A supplier user would sign up as a supplier user with a unique username and at least one specific area or field of specialized knowledge or expertise. In addition to this, the supplier user would create a supplier user profile. The supplier user profile would detail the supplier user's qualifications in the specific area or field, with the qualifications including educational background, college or university degrees or certifications in that area or field, any designations received, relevant awards, as well as years of experience in that area or field. As well, the profile would also detail any other relevant details that may be pertinent to the supplier user's specific field or area of expertise. In addition to the supplier user's qualifications in the profile, the supplier user may also provide different keywords or relevant terms to the supplier user's expertise. These keywords, which may be added to by the system, depending on the configuration, are also included in the supplier user's profile and may be used to determine if the supplier user has the expertise or knowledge desired by a specific consumer user. The supplier user's profile may also include a short video or presentation from the supplier user explaining or introducing their knowledge expertise and general personal overview.

It should be clear that the profile may also include the supplier user's urban location, address of residence, academic credentials, external personal references, memberships, club affiliations, hobbies, favourite foods, weight, height, eye color, favourite musicians, favourite authors, as well as the supplier user's biography or resume. As can be imagined, the data in the profile may be implementation specific and may be dependent on what the supplier user is willing to present as being viewable by others.

For clarity, any user may be, simultaneously, a consumer user and a supplier user. Such a user would, initially, sign up with the service provider as a supplier user or a consumer user. At a later date, that user can then convert the account as one that is both a supplier user and a consumer user with the provision of further information as necessary. As an example, a consumer user would detail his interests in his profile when signing up for an initial account. Such a consumer user could convert his account into both a consumer user and a supplier user by indicating his area(s) of expertise, his qualifications, and other information that would be required of supplier users.

In one implementation, the server and the processor work in conjunction with the database to find supplier users who have the relevant expertise, knowledge, and/or experience. To determine which supplier user has the requisite specialized knowledge or expertise, the processor receives the query and parses the query. Keywords from the query are then extracted from the parsed query. The keywords are then collated and equivalent keywords are generated and/or retrieved from the database. Keywords from the original query are analyzed by the processor and related keywords are added to the list of relevant keywords. Variations in spelling, usage, and/or terminology can be taken into account when generating a suitable list of relevant keywords. As an example, an American consumer user may enter a query which includes the term “sofa”. To ensure that supplier users with relevant expertise may be taken into account during the search for suitable supplier users, the terms “chesterfield” and “divan” may be added to the list of relevant keywords for the search. As well, if a Canadian enters a query relating to “colour”, a keyword “color” is also used so that American supplier users who entered “color” as a keyword in their profile will be picked up when searching for relevant supplier users. Similarly, the processor may also search a database of related keywords to generate more relevant keywords to be used in the search for supplier users. As an example, a query with a keyword “barbecue” may generate the similar or related keywords “BBQ”, “B-B-Q”, “cooking”, “grilling”, “broiling”, “marinade”, and “sauces”. In some implementations, the processor may also search for equivalent keywords in other languages in case supplier users use similar terms in their profiles. Thus, a query involving the keyword term “BBQ” or “barbecue” may generate and include similar keywords “braai”, “char siu”, “lechon”, “chuanr”, “yakiniku”, and “yakitori” to the list of keywords relevant to the query.

Other methods of ensuring relevant keywords are generated for a query may also be used. As an example, category matching may be performed such that keywords parsed from the query are matched with keywords in the same category. Thus, if a query had the keyword “cars” was entered, a matching category “cars” may include other relevant keywords including “hot rod”, “jalopy”, “racing”, “coupe”, and “convertible”. These and other keywords in the same category may thus be added to the keyword list for the query “cars”. Filtered matching may also be used. A query may thus not just involve which keywords to search for but also which keywords to not search for. Thus, a query for “cars” may be modified with “but not roller coasters” (since roller coaster passengers also ride in “cars”). Such a capability would allow for keywords that relate to “roller coasters” to be filtered out of the relevant keyword list. Other methods that make use of educated textual guesses for the relevant matching keywords may also be used.

Once a list of relevant keywords have been generated from the original query and by reference to one or more suitable databases of equivalent or related terms, the list of relevant keywords (including the original query words) is then used to search the database for profiles of supplier users whose keywords, names (first and last), and usernames match the keywords in the list. The profiles found are them collated into another list and may be ordered by relevance. It should be noted that a profile's relevance to a specific query may be determined using different methods. Relevance may be determined by as simple as the number of keywords in the profile that match the keywords in the relevant keyword list. Thus, a profile that has the most number of keywords that match those in the relevant keyword list from the query would be considered to be the most relevant to that specific query. Similarly, the number of keywords in the relevant keyword list that match words in a profile's description and/or profile keyword list may determine a level of relevance for that profile.

Relevance may also be determined based on the order that keywords are presented in a profile. Thus, between two profiles, the profile with more matching keywords to the keyword list and more matching keywords that are listed earlier in the profile would be considered to be more relevant. If a profile thus had its first three keywords listed as “cars”, “hot rods”, “automobiles”, that profile may be considered more relevant to a query about automobiles than another profile where the same keywords are listed at the bottom of its list. Similarly, relevance may be determined relative to how often matching keywords appear in a profile's written description. Thus, a profile with 10 matching keywords in its description may be considered more relevant than a profile that only had 4 matching keywords in its written description.

Profiles that pass a threshold test for relevance are then placed in a list by the processor. The threshold test may be as simple as having at least one or at least two keywords in the profile keyword list that match keywords in the relevant keyword list. For this simple case, profiles with only one matching keyword would not be included in the list. The profiles that pass the threshold test and that are in the relevant profile list can then be ranked by the processor based on preferences by the consumer user. Ranking may be determined by relevance (the most relevant profiles being placed at the top of the list), by recency of interaction with a different consumer user (the profiles of supplier users with the most recent interactions with consumer users would be highest on the list), or by any other criteria implemented in the system. In one implementation, consumer users who interact with specific supplier users are allowed to leave feedback for those specific supplier users. Feedback can take the form of a grade ranging from (in one example) 0 to 10. Aggregated or averaged grades for each supplier user can thus be added to the supplier user's profile and this aggregated or averaged grade can also be used for ranking purposes.

In one implementation, ranking is determined by the number of successful interactions a supplier user has with consumer users. Thus, if two supplier users have the same relevance to a specific search, the supplier user with more interactions (e.g. video and audio calls) with consumer users is ranked higher. If, however, all other indicia are equal between two supplier users (e.g. same number of interactions, same feedback rating, etc., etc.) then these supplier users are ranked alphabetically in order of their first, their last name, or their username. Note that since usernames are unique between any two users, then ranking using usernames is preferred if all other indicia between supplier users are equal.

With the list of supplier users with relevant specialized expertise or knowledge compiled, the processor then sends this list to the device of the consumer user who entered the original query. The consumer user can then, should he wish, reorder the list, adjust the ranking criteria, and/or review the list entries. The consumer user can reorder the list using multiple criteria including geographic proximity, rating system score, number of previous interactions with the specific consumer user, frequency of interactions with other consumer users, gender, age, or income. Once the list has been reviewed, the consumer user can select a supplier user to interact with to thereby address the consumer user's original query.

Once the consumer user has selected a specific supplier user, the selection is sent to the server where the processor activates one or more communications modules to allow the consumer user to interact with the specific supplier user. It should be noted that this is done only if both the consumer user and the specific supplier user are both online at the same time. If both are online at the same time, an audio based communications module or a video/audio communications module can be activated to allow an audio call or an audio/video call between the two to be activated. Should either participant desire it, and if both devices used by the consumer user and the supplier user are capable, other communications modules may be activated. As an example, a communications module that allows for the sharing of a desktop between the consumer user and the supplier user may be activated. This would allow the supplier user to show the consumer user the supplier user's desktop if the supplier user needed to show the consumer user something on his computer. Similarly, a communications module that allows for the sharing of a digital whiteboard between the consumer user and the supplier user can be activated if, for example, the supplier user needed to show the consumer user how to solve a particular type of equation. The audio based communications module, simultaneously activated, would allow the supplier user to talk to the consumer user while the supplier user showed the equation and its solution on the digital whiteboard. At the same time, the consumer user can ask specific questions if something is unclear about the supplier user's explanation.

It should further be clear from the above that other communications and video/audio technologies, which may improve communications and/or interactions between the supplier user and the consumer user may be included in the various communications modules. As an example, virtual reality (VR) technology or VR-based communications modules may be included as part of the system. Such VR-based modules may allow the consumer user to view/experience an environment being explained by the supplier user or they may allow the consumer user to interact with a supplier user's suitable avatar in some capacity. As well, augmented reality (AR) based communications modules may also be part of the system. Such AR based communications modules would allow the consumer user to see, for example, nutritional information on the various ingredients being used by a supplier user who is teaching the consumer user how to cook a certain type of food. Or, the AR based communications module may allow the supplier user to be alerted about an upcoming scheduled session. In addition to the above, other communications modules may allow the consumer user and supplier user to use holographic 2D or 3D projectors, thin film displays, and heads-up displays.

It should be noted that each interaction or session between a consumer user and a supplier user is timed by the server and/or the processor on the server. Once the interaction between the consumer user and the supplier user has terminated, the server and the processor can, based on the length in time of the session or interaction, calculate other metrics regarding the interaction. At the beginning of each session or interaction, the processor activates a timer and, once the session has ended, the timer is terminated and the elapsed time is saved. The timer is, preferably, one that measures time in seconds or minutes as metrics which are considered on a per second or per minute basis for the supplier user would be useful. These metrics can be calculated based on the session's length of time and the supplier user's metric calculation basis as detailed on the supplier user's profile. Of course, any factors that affect the metric calculations may be taken into account when calculating such metrics.

While interactions conducted between the consumer user and the supplier user using the communications modules are generally timed by the processor, it should be clear that only direct, real-time or near real-time interactions are timed. Thus, voice communications between the consumer user and the supplier user are timed, along with real-time (or near-real time) video sessions, and other real-time or near real-time sessions. Thus, text communications such as text chats (which are not necessarily conducted in real-time) are not timed (but are recorded). Similarly, other real-time sessions, such as those where the supplier user shares his or her screen with the consumer user to explain a topic, are also timed. Sessions that are necessarily real-time or near real-time are timed while sessions that do not need real-time or near real-time interactions between the participants are not timed. Of course, sessions where the consumer user is not communicating or interacting in real or near real-time with the supplier user are not timed.

It should also be noted that, in one implementation, all interactions or sessions between supplier users and consumer users are recorded and stored on the server. This allows for the consumer user to go back and review the session or interaction in the event the consumer user may have missed or misunderstood a point made during the interaction. This also allows the supplier user to review the session to help him with improving his advice giving technique or even to review what he mentioned during the session. Thus, any video, audio, or any other communications sessions or interactions between the supplier user and the consumer user is stored on the server and is accessible to both the supplier user and the consumer user.

As noted above, the consumer user can provide a grade or a score to a supplier user that the consumer user has interacted with. This grade or score operates as feedback regarding the supplier user's expertise and general usefulness and can be placed on the supplier user's profile. Another method of scoring or grading the supplier user may be in the form of a five star feedback system where the consumer user scores or grades the supplier user out of five stars. In addition to the star rating system, some implementations allow the consumer user to leave a short text feedback regarding the session or interaction with the supplier user.

In addition to the above, supplier users may be graded or scored by consumer users according to specific characteristics or categories. As an example, a supplier user may be scored by consumer users based on the supplier user's knowledge, terseness, and/or accuracy.

To ensure that the scoring or rating system is not skewed by ratings by high use pairs of supplier users and consumer users (i.e. by ratings from the same consumer users about the same supplier users), multiple ratings from the same consumer user may be factored down or adjusted accordingly. Thus, for example, instead of receiving credit for five glowing ratings from a single consumer user A, a supplier user B may only receive credit for a portion of those five ratings. To help promote use of the system, a factor in the ratings system may be included that provides higher ratings to frequent supplier users. Thus, for example, a supplier user with five glowing ratings and who has used the system ten times will be awarded a higher rating than another supplier user with the exact same five glowing ratings but who has only used the system 6 times. Other factors that take into account the length of interactions with consumer users as well as the number of completed interactions with consumer users may also be used. For such implementations, supplier users with longer interactions and higher number of completed interactions would be rated higher than other comparable supplier users.

While consumer users can leave feedback for supplier users, suppliers users may also, according to one implementation, leave feedback for the consumer user. In implementations where consumer users are required to have profiles, the supplier user may also leave feedback regarding their interaction with specific consumer users. This feedback can be listed/posted on the consumer user's profile and would provide supplier users an indication as to whether the consumer user is one that the supplier user may or may not wish to interact with.

It should also be noted that, in some implementations, the supplier user may also be given the option to turn down requests for sessions or interactions from consumer users. When the server receives the consumer user's selection from the list of supplier users with relevant expertise, the server may also send the consumer user's profile to the selected supplier user. This provides the supplier user with the option to decline (or accept) the consumer user's request for a session or interaction. As noted above, the consumer user's profile may include a rating or grade from supplier users who have interacted with the consumer user. In addition to the rating or grade, the profile may include a text feedback from other supplier users. Supplier users can thus be given a measure of control as to who they may interact with. In addition to sending the consumer user's profile to the supplier user, the server may also send the consumer user's query to the supplier user prior to the supplier user accepting the consumer user's request for a session or interaction. This way, the supplier user can assess whether he or she has the requisite expertise or experience or knowledge regarding the query. The consumer user's profile as well as the query and any requests for a session from consumer users may be sent to the supplier user by way of the app or application or by way of the website. Thus, a supplier user logged in to the website or to the app may be notified by a specific message or a pop-up indication that a consumer user is requesting a session. The supplier user can then accept or decline the request based on the query, the consumer user's profile, or any other consideration.

It should be clear that other factors that may affect interactions between consumer users and supplier users may be taken into account when matching the consumer with the supplier. As an example, language, country of origin, and/or demographics may be taken into account. Thus, if a specific consumer user is searching for expertise on a specific subject, a supplier user who does not have a single common language with that consumer user would not be presented to the specific consumer user. At the very least, supplier users to be listed as relevant to a consumer user would have at least one common language with that consumer user. In some implementations, supplier users located in the same country as the querying consumer user may be preferentially presented to or ranked higher when presented to the consumer user. Of course, for such implementations, other supplier users who are not in the same country would also be presented to the consumer user, depending on the system settings or on the consumer user preferences.

While the consumer user may request a session with a specific supplier user, if the supplier user is not online at the same time or is otherwise unavailable, the system may provide the requesting consumer user with suitable times and/or dates during which the supplier user is available. The consumer user may then request a session or interaction with the specific supplier user at one or more specific time and date slots. It should be noted that, while some supplier users can be available for an instant session, other supplier users may only be available for scheduled sessions. For such supplier users, specific icons or other indications on the consumer user's devices may be used to indicate that only scheduled sessions are available.

Once a consumer user has scheduled a session with a selected supplier user and once the selected supplier user has accepted the request, the system may send out reminders to both the consumer user and the supplier user about the scheduled session. On the time and date of the scheduled session, the system checks if both consumer user and supplier user are online and, if they are, a suitable communications module is activated to allow for interactions between the two users. Once the session is over, the system continues as above regarding billing the consumer user.

In addition to providing interactions with specific consumer users on a one-to-one basis, supplier users may also provide seminars or webinars to interested consumer users. A supplier user can set up a scheduled live webinar or web-based seminar by selecting a time and date for the seminar, and a topic/subject (relating, of course, to the supplier user's area of specialized expertise). The supplier user can then send out a notification about the upcoming webinar to consumer users who have previously interacted with the supplier user, other consumer users who have shown an interest in the field or topic, and to others using various notification avenues (e.g. email, messages, posts on a message board, etc., etc.). Consumer users can sign up/reserve a spot for the webinar either by indicating their interest or by clicking a suitably configured button on the app or website. On the time and date of the webinar, the supplier user can thus set up with the system so that a one-to-many video (or video/audio) link is active and the webinar is simply a live webcast for those who have signed up. During the live webinar, the supplier user can take questions (either text based or voice based) from the consumer users receiving the audio/video feed from the webinar. The supplier user can thus interact in real-time (or in near real-time) with multiple consumer users simultaneously.

In a similar vein to the above, supplier users can also provide recorded content to consumer users. Thus, instead of a live webinar, a recorded webinar by the supplier user can be provided to consumer users on an on-demand basis. This allows consumer users to view pre-recorded content in the event the supplier user might not be available for a live session. The pre-recorded content can be listed and accessed by way of the supplier user's profile. Once a consumer user selects a pre-recorded session for viewing from a supplier user's profile (or from a list of available pre-recorded content), the video/presentation/content can then be streamed to the consumer user's device.

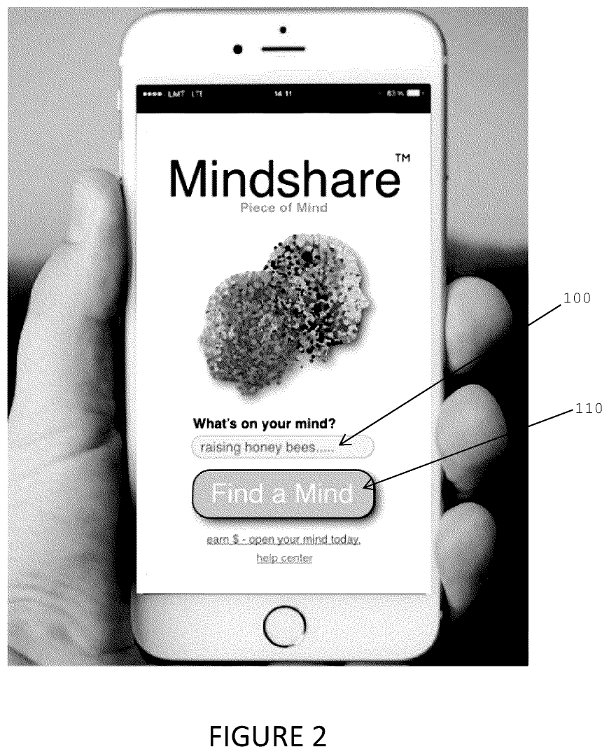

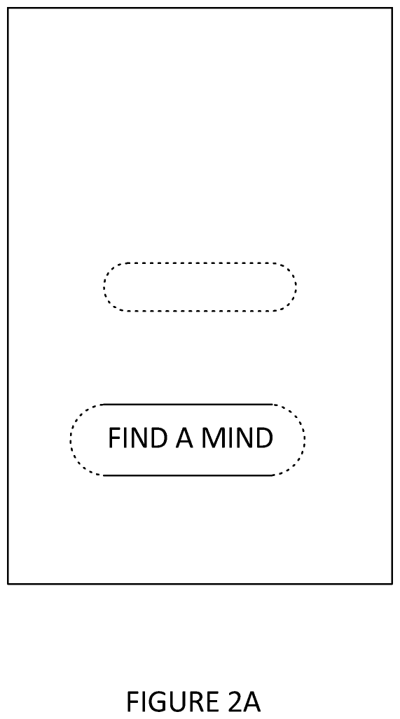

Referring to FIG. 2, a screenshot of an app used in one implementation of the invention is illustrated. The examples provided are for a mobile phone or tablet implementation but similar functionality applications or websites for use with other computing devices may, of course, be used. As can be seen, a text box 100 is provided along with a query button 110. The consumer user enters a query into the text box 100 and then presses the query button 110 to send the query to the server. A similar landing page for use with the system is illustrated in FIG. 2A. As can be seen, the elements in the page may only include the text box where a query can be entered and a “Find A Mind” button that initiates the search.

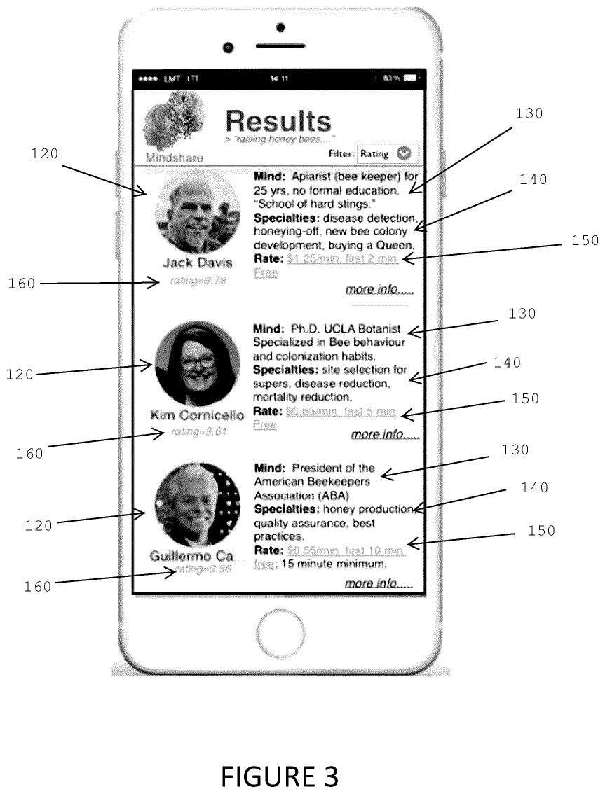

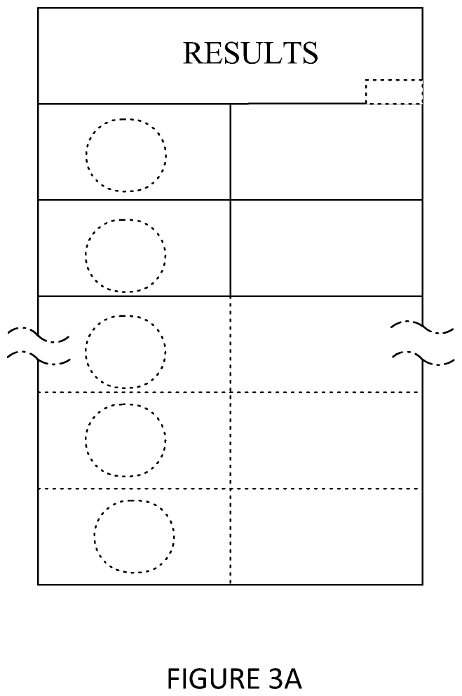

Referring to FIG. 3, a listing of supplier users found in response to the query entered is presented. For this example, the query entered related to bee keeping (“raising honey bees”). The listing in FIG. 3 provides smaller versions of profiles for supplier users with the requisite specialized expertise or knowledge. As can be seen, each list entry includes the supplier user's picture 120, the supplier user's qualifications in the specialized field or area 130, the supplier user's specialties in that field or area 140, the supplier user's billing rate 150, and the supplier user's feedback rating 160. A non-specific results page is illustrated in FIG. 3A, detailing the elements in the user interface. As can be seen, the results page gives the details for a number of supplier users whose expertise matches the query. For each supplier user in the results page, a picture of the supplier user is provided on the left side along with a box on the right side for the supplier user's name, a description of the supplier user (i.e. a “Mind description”), the supplier's user's specialization in terms of expertise, and the supplier user's rating. The listing may, of course, be reordered based on multiple factors such as rating, geographic proximity to a region or user, supplier user name (i.e. alphabetical), or historical data such as a supplier user's frequency of interactions with other users.

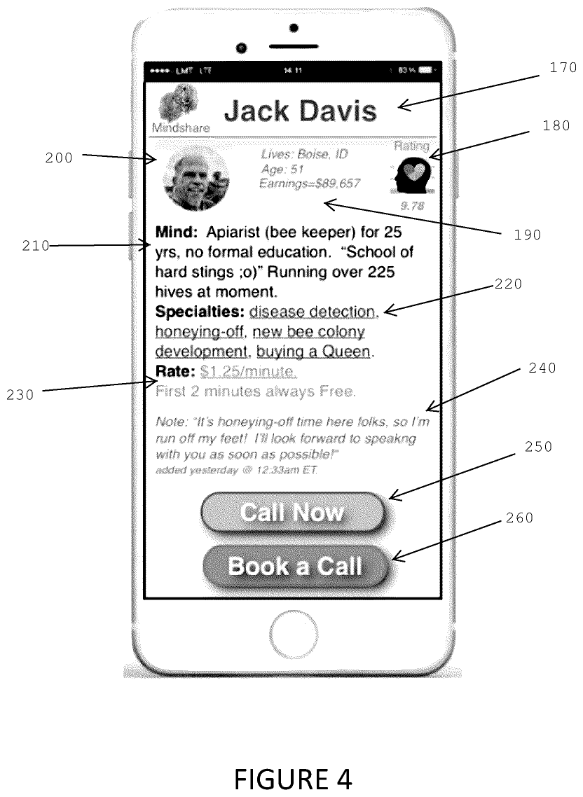

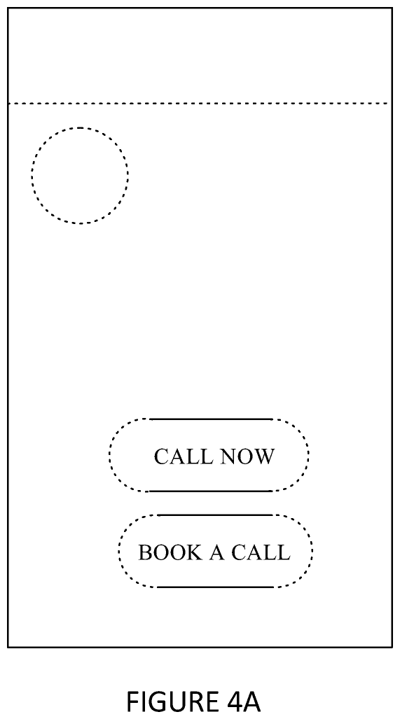

After reviewing the list, a consumer user may then click or select on one of the profiles in the list. Such a selection presents the consumer user with the selected supplier user's full profile. Such a profile is illustrated in FIG. 4. As can be seen, the full profile includes the supplier user's name 170, the supplier user's rating 180, as well as the supplier user's location, age, and earnings 190. A picture 200 of the supplier user may also be included. The qualifications 210 (provided by the supplier user when creating a profile and edited as necessary) is also provided. The supplier user's specialties 220 are also provided. Each of the specialties may be activatable to provide the consumer user with further information on that specific specialty. These specialties may also be used by the system as keywords against which the query can be matched against to determine if the supplier user has the requisite expertise. A billing rate 230 and any discounts or conditions regarding billing are also provided. A tagline 240 that uses a quote or other text information from the supplier user is also given. This tagline 240 may also be editable by the supplier user and can be used to give an indication of the supplier user's availability. A CALL NOW button 250 can also be provided. The CALL NOW button 250 is provided if the supplier user is online and available for a session with the consumer user. As an alternative to an immediate session with the supplier user, the consumer user can click a booking button 260. The booking button 260 provides the consumer user with times and dates when the supplier user may be available for a session or interaction. A consumer user would select a time and date and this request for a session at that time and date would be sent to the supplier user. Other configurations for the profile screen may, of course, be possible. As one alternative, the keywords for the supplier user, other than the specialties, may also be provided on the profile screen.

For clarity, FIG. 4A illustrates a generic full profile page for a supplier user and illustrates the various elements on the page. As can be seen, the supplier user's picture is provided at the top left corner and a space is provided on the top right corner for supplier user's name, user description, specialization, and rating for the supplier user. Instead of a picture, a video may be used. Along with the above, a CALL NOW button and a BOOK A CALL button are used to provide instant access to the supplier user or, if the supplier user is not available to allow the consumer user to schedule an appointment with the supplier user. This profile view may also indicate the supplier user's rating, comments from consumer users, a summary of the supplier user's knowledge and specialties, and whatever notes the supplier user may wish to share with consumer users viewing the profile.

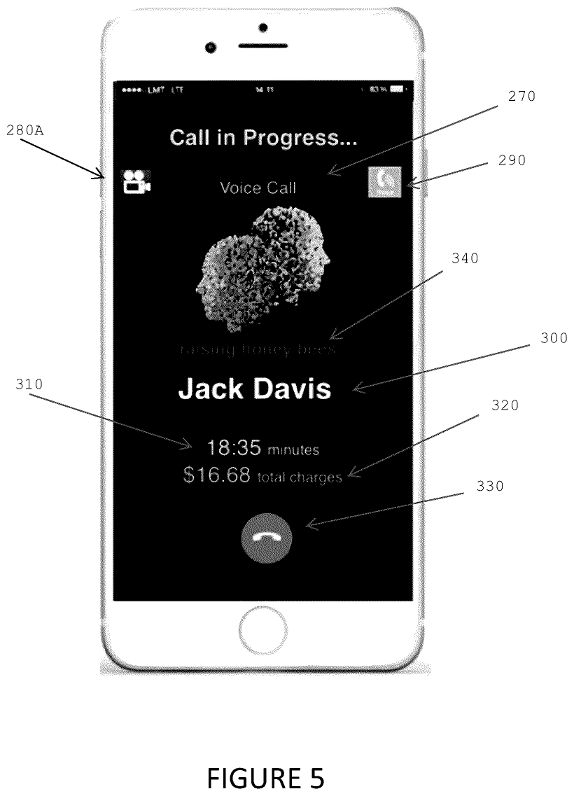

In the event the consumer user requests an immediate session or interaction with the supplier user, an interface screen as illustrated in FIG. 5 would be presented. For this interface, an indication 270 of the type of communications interface being used is provided. In this example, a voice call or audio communications between the consumer user and the supplier user is provided. Other possible communication methods available may also be indicated on the interface. As can be seen, an icon for video conferencing 280 is provided, indicating that video conference capabilities are present and available. Another icon 290 indicates that the audio communication route is active. The supplier user in session is identified 300 and the length of the interaction or session is also indicated 310. The total charges for the session are provided as a running total 320. A hang-up or session termination button 330 is also provided. The consumer user's query 340 is provided to give context to the session.

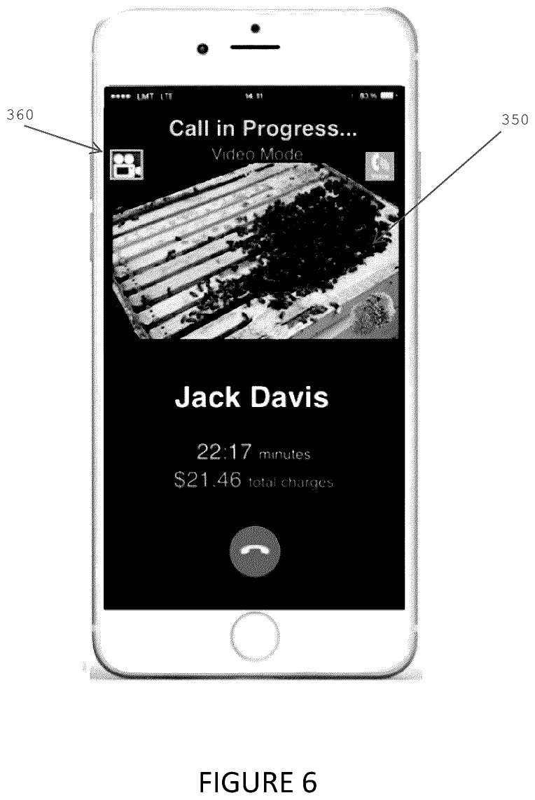

In the event a video conference or a video call is desired, the interface provided in FIG. 6 may be used. As can be seen, the video mode interface has the same features as the audio mode interface in FIG. 5, with the exception that a video feed window 350 is active and the video icon 360 is active.

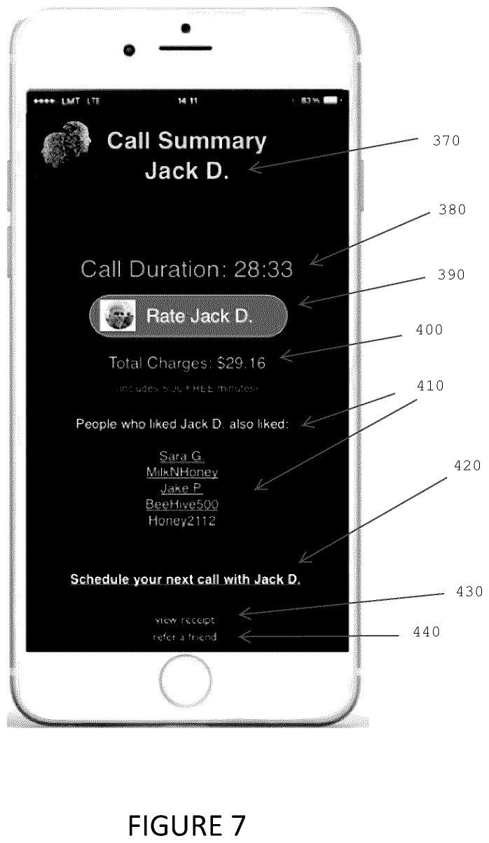

Once the session has been terminated, the consumer user is provided with a session summary (or a call summary) screen. One such screen is provided in FIG. 7 as an example. As can be seen, the session summary may include identification 370 of the supplier user and the time length of the session 380. The consumer user is provided with an opportunity to rate, grade, or otherwise provide feedback regarding the session with the supplier user 390. The total charges 400 for the session are also provided. To help promote other supplier users, other supplier users with potentially similar expertise are provided with links 410 and a link 420 for another session with the same supplier user is also given. A receipt for the session may be viewed (link 430) as well as a referral link 440 so that the consumer user may refer someone else to the same supplier user.

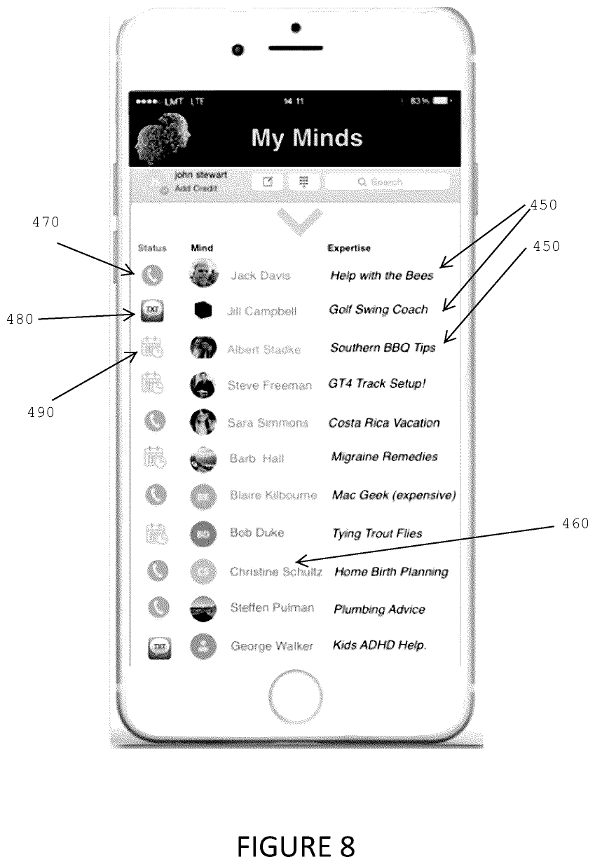

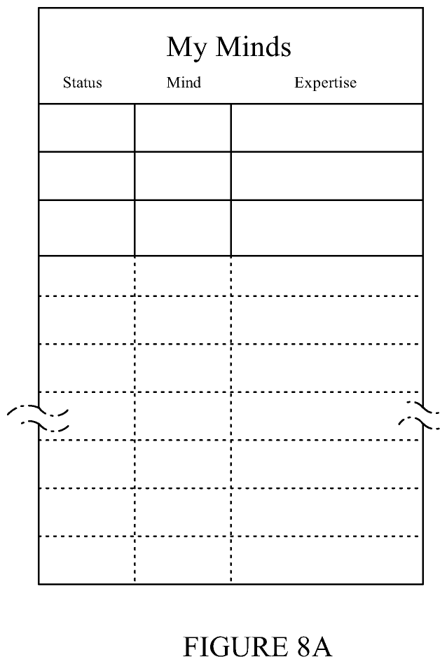

Referring to FIG. 8, a screen shot of a consumer user's contacts or listing of supplier users that the consumer user has interacted with is provided. As can be seen, the list provides the names 460 and specialties 450 of the various supplier users previously used or consulted by the consumer user. Each supplier user is also provided with a status icon that indicates whether the specific supplier user is available for an immediate session or whether the consumer user will need to book or schedule a session. Icon 470 indicates that a particular supplier user is available for an immediate voice or audio session. Icon 480 indicates that this supplier user is available for a text based session where the consumer user and supplier user exchange text messages to respond to the consumer user's query. Icon 490 indicates that the supplier user is not available for an immediate session and that the consumer user will need to book or request for a scheduled session with the supplier user.

Referring to FIG. 8A, a generic user's contact list is illustrated. As can be seen, the contact list includes a status for each supplier user, a “mind” field for the supplier user's name and picture, and an expertise box for a short description of the supplier user's expertise.

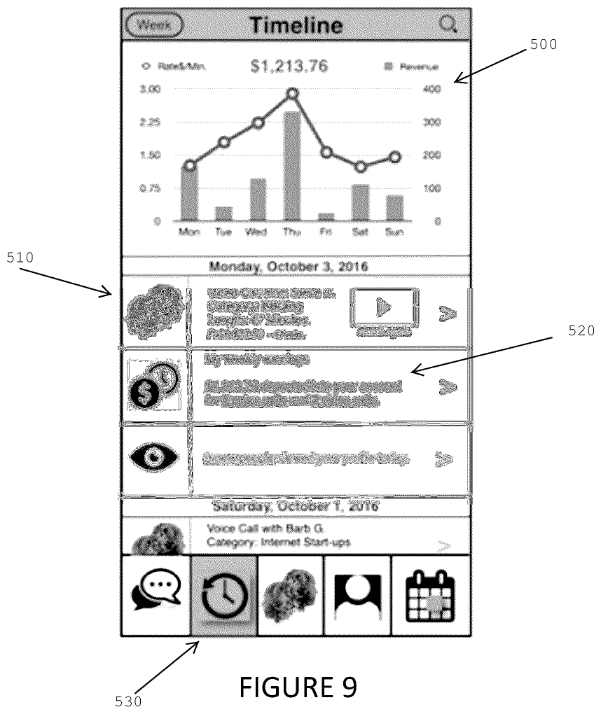

To assist the supplier user in managing his or her operations as a subject matter expert, the system provides a number of tools. FIGS. 9-12 illustrate sample screen shots of such tools. It should be clear that these specific screen shots and tools relate to the app or website as provided for supplier users and not for consumer users. However, similar tools to those illustrated in FIGS. 9, 10, and 12 are provided for the consumer user as will be explained below.

Referring to FIG. 9, a timeline tool and user interface is illustrated. For the timeline tool, the supplier user is provided with a graph of the supplier user's income on a weekly or monthly basis. This provides the supplier user with a better indication of how his or her earnings are progressing or regressing. A summary 510 of each day's developments is also provided. As can be seen, any sessions provided are listed, along with the consumer user involved, the category or expertise involved, as well as the length of the session. As well, developments 520 regarding earnings are also listed. To help the supplier user navigate the tools provided, a quick navigation bar is provided at the bottom of the screen. The timeline tool is quickly accessed by activating the relevant timeline icon 530.

A timeline tool similar to that in FIG. 9 is also provided to consumer users. However, the timeline tool for the consumer user may have, instead of a summary or graph of amounts earned, a summary or graph of amounts spent in consulting supplier users. As well, the consumer user timeline tool may include details or a recap of sessions or interactions that the consumer user has had with various supplier users on specific days. This recap will include the name of the supplier user interacted with, the length of the session, the cost of the session, and the quick access links to the recorded versions of the session. And, similar to the timeline tool for the supplier user, the timeline tool for the consumer user will detail upcoming sessions with supplier users.

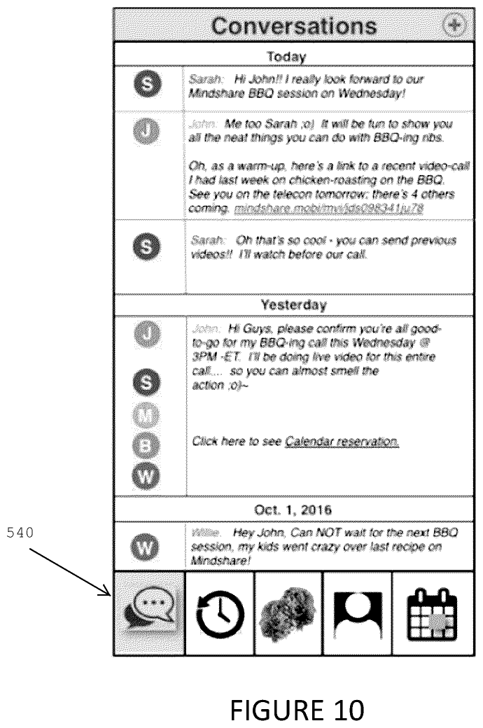

To manage text messages or conversations that the supplier user may have had with other supplier users or with specific consumer users, a text management tool is provided and a screenshot for such a tool is illustrated in FIG. 10. As can be seen from FIG. 10, this tool provides the supplier user with all the text messages and conversations the supplier user has had each day. The text management tool can be accessed by activating the text management icon 540 at the bottom of the screen.

The consumer user will also have a text management tool similar to that illustrated in FIG. 10. The consumer user version of this tool provides the consumer user with all the text messages and conversations the consumer user has had each day.

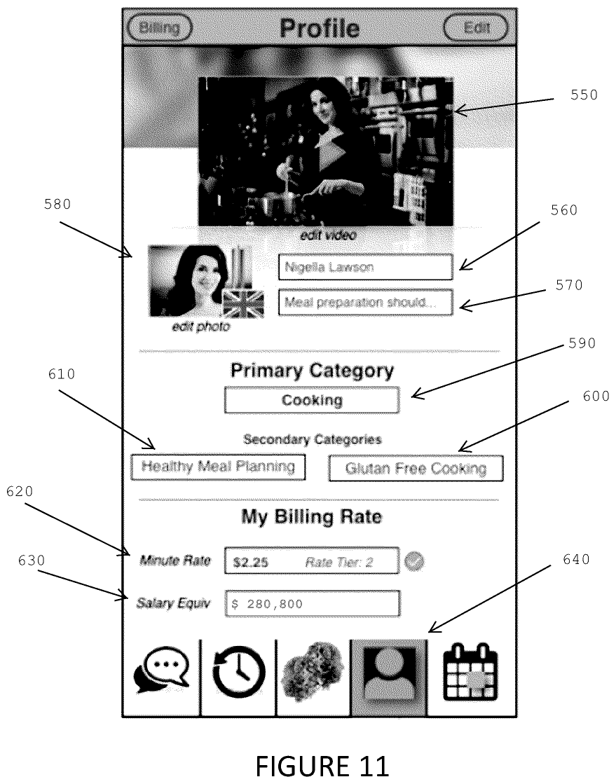

To manage the supplier user's profile, a profile management tool is provided. A screen shot of this tool is provided in FIG. 11. The profile management tool allows the supplier user to view, edit, and manage his or her profile. The profile management tool allows the supplier user to upload and post a video 550 that will be played whenever the profile is viewed. The supplier user's name 560 can be edited as well as the tagline 570 associated with the profile. The supplier user's photo 580, a thumbnail of which will be viewable in the listings view by a consumer user, is also editable/replaceable. To assist the consumer user in determining if the supplier user has the correct expertise, the main category 590 of the supplier user's expertise is provided. For ease of use, the system may only allow a fixed number of specific main categories of skills or expertise. Secondary categories 600, 610, related to the main category, may also be provided to help specify the supplier user's other related specialties. In one implementation, secondary and tertiary categories of the supplier user's expertise that are unrelated to the main category may also be displayed. The supplier user's billing rate 620 (or other metric basis rate) is also editable. A supplier user's yearly salary 630 (based on a 40 hour work week) is also present based on the billing rate and may be displayed to the supplier user. This profile management tool may be accessed by activating the relevant icon 640 at the bottom of the screen.

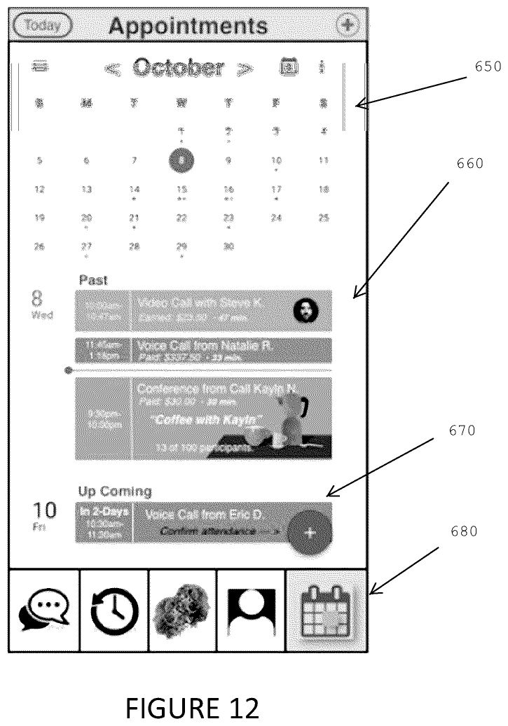

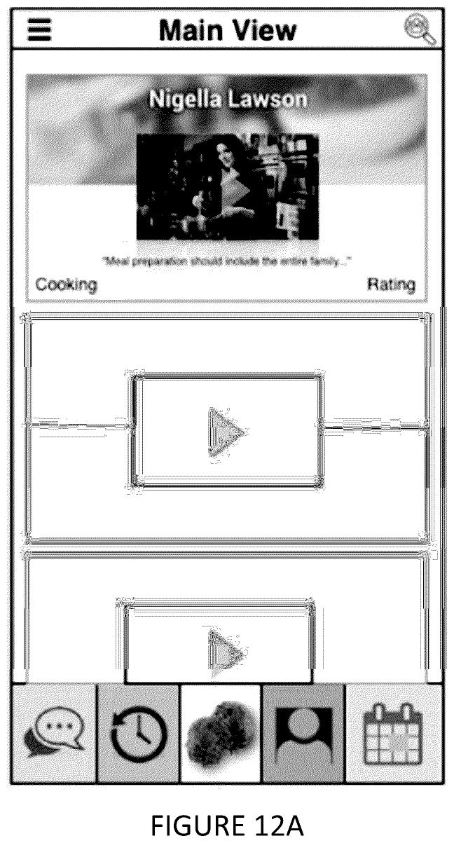

Another tool which may be provided for the supplier user is an appointment manager tool. Such a tool would help the supplier user in managing previous and upcoming sessions with consumer users. An example of a screenshot of such a tool is shown in FIG. 12. As can be seen, a calendar 650 is provided. Past appointments or sessions are listed 660 with details about the sessions. Upcoming sessions are also listed 670 along with how much time is left before the sessions. The tool may be called up by activating the calendar icon 680 at the bottom of the screen.

Similar to the supplier user, the consumer user is also provided with an appointments manager tool. The consumer user version of the appointments manager tool has similar functions to the supplier manager version with listings and details about past appointments or sessions, upcoming sessions, and how much time is left before the upcoming sessions. Links to copies or recordings of past sessions may also be provided to both the supplier user and the consumer user versions of the appointment manager tool.

Referring to FIG. 12A, a main view or an initial user interface view of an app according to one aspect of the invention is illustrated. As can be seen, the main view includes a supplier user's profile picture, the supplier user's specialties/expertise, and quick links to recorded copies of the most recent sessions or interactions. As well, the main view includes shortcuts or quick access icons at the bottom of the screen to allow the supplier user to use the various management tools provided. A similar main view for the consumer user version of the app may include the quick access icons for the management tools available to the consumer viewer as well as a suitable main view picture for the consumer user (e.g. similar to a wallpaper or a cover picture) and shortcuts to recorded versions of the most recent sessions that the consumer user has participated in. The main view also provides either the consumer user or the supplier user to perform searches or enter queries by means of the magnifying glass icon at the top right corner of the user interface. This allows for quick access to entering queries for the consumer user and quick search capabilities for the supplier user. As well, the top left corner allows for easy and accessible category menus for the consumer user. Thus, instead of performing a search or entering a query, a consumer user can activate the upper left icon and be presented with categories of subject matter available. Each category can further be broken down into more detailed sub-categories so the consumer user can find subjects which are more focused to his needed subject matter or expertise.

It should be noted that, in addition to the components of the system illustrated in the Figures and discussed above, the system may include other modules. One such module may be a calculation module. A calculation module would perform calculations of metrics relevant to a consumer user and/or to a supplier user. To perform this, the calculation module would access the database, retrieve the relevant metric basis rate for the relevant supplier user, determine how long a specific session lasted, and calculate the metric for the session. Of course, the calculation module would take into account any factors or other related considerations for the session. If necessary, the calculation module may access the timer that times a session and the calculation module may retrieve the session length directly from the timer.

A backup module may also be present in the system. The backup module would ensure that proper and timely backups of the data in the database are performed. Similarly, the backup module would ensure that the relevant settings and configurations for the system are also backed up so that, in the event of a system crash, the system can be quickly recovered. In one implementation, the backup module ensures that the databases are backed up hourly to ensure minimal data is at risk of being lost. These backups are on a separate system than the operational servers to further minimize risk.

It should be noted that, as the number of consumer users and supplier users increase, the system and the server may get bogged down. To ensure that the user experience is of an acceptable level, a load balancing module may be used. Such a load balancing module monitors the resources available to the system (including memory, storage, processor capacity, and network transmission bandwidth available). If the module determines that free resources reach a specific threshold, the module off-loads tasks (where possible) to other available servers, databases, or processors. Thus, a server cluster may be used to operate the system such that a single logical database is present. Once one server has too many users or too many sessions in progress, the load balancing module may off-load or pass other incoming connections, users, or sessions to other servers in the same server cluster. Thus, if the load balancing module determines that one or more servers are being taxed too heavily, the load balancer can deploy one or more servers at its own discretion, thereby allowing for automatic scalability of the system based on the system's real time needs. The load balancing module can also remove one or more servers if such servers are not currently needed.

As noted above, the system includes the capability to record and store interactions or sessions between the supplier user and the consumer user. These recorded sessions can be played back by any of the participants and are accessible by quick links through the appointments management tool, the timeline management tool, or by other means using different user interfaces used by the system. Depending on the configuration of the system, the recorded sessions may be stored on the database or on another system which communicates with the system of the invention.

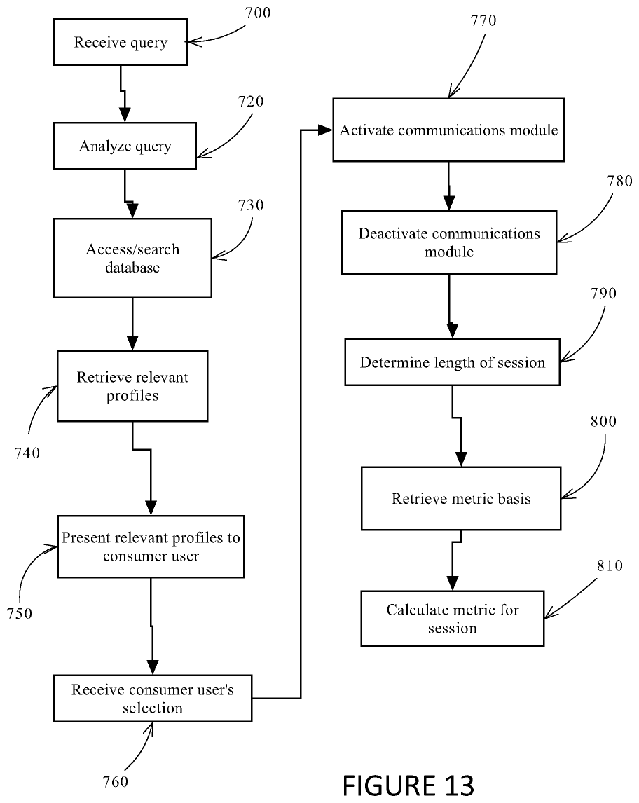

Referring to FIG. 13, a flowchart detailing the steps in a method according to another aspect of the invention is illustrated. The method detailed in FIG. 13 is for facilitating interactions between consumer users and supplier users. As can be seen, the method starts with step 700, that of receiving a query from a consumer user. This query is transmitted to a server and the query is analyzed by the server in step 720. In step 730, a database of supplier user profiles is accessed and the profiles of supplier users with relevant expertise to respond to the query are retrieved (step 740).

The profiles retrieved are then compiled and presented to the consumer user (step 750). Once the consumer user has selected a selected supplier user, the system receives the consumer user's selection (step 760). Once the consumer user has also requested a session with the selected supplier user and once the supplier user has accepted the request, the system activates at least one of the communications modules (step 770) for the session between the consumer user and the supplier user. Once the system receives a deactivation signal for the session, the communications module is deactivated (step 780). The timing or length of the session is then determined (step 790). This can be done by simply accessing the timer used to time the session. The basis for a metric for the session is then retrieved (step 800) and the metric for the session is calculated (step 810) based on the timing and the metric basis previously retrieved. Other steps may also be taken including receiving feedback from the consumer user and/or the supplier user for the session. Such feedback can then be used to calculate the aggregated rating or score for the consumer user or the supplier user.

It should be noted that, in one embodiment, the system may be implemented as an internal communications system for accessing expertise within an organization or as an expert consultation system for use by a closed group of consumer users. For such an embodiment, the system would store profiles of employees with specific expertise and other employees would be able to avail of such specific expertise using the system. As an example, employee A from the accounting department might have need of expertise regarding the Microsoft Word™ software package. Instead of simply calling the IT help desk, employee A would search, using the system, for a fellow employee who is available for a quick consultation and who specializes in the specific software package. This would save employee A the time it would normally take to navigate a potentially arcane IT department with its various levels of technical support. Similarly, another employee in another department might have a question regarding marketing and, instead of blindly calling the marketing department, that employee could search for specific expertise (within the marketing department) that could address his queries.

In the above embodiment, something akin to tracking how much time used in querying experts may be used. As an example, instead of people from one department having to remunerate people with expertise in another department, tracking can be performed in the form of a budgeted time for each department. Thus, department A may have X number of expertise minutes (on a monthly or yearly basis) it might use in consulting people using the system. Every time a person from department A uses the system to consult with other employees who have specific expertise, the time used is set off against department A's budgeted time allotment. As an example, we can assume department A is allocated 200 minutes a month to consult with, for example, department B. Any time spent by an employee from department A consulting with an employee from department B for expertise (and using the system) would be deducted from the allocated 200 minutes.

The system may, in another implementation, also be used by an organization to provide expert consultant (a closed group) availability to one or more individuals or organizations or to, essentially, another closed group of consumer users. Of course, the supplier users would also be a closed group in this implementation. As an example, an accounting firm, with multiple accountants with varying levels and areas of expertise, may use the system to provide accounting expertise to individuals or to other organizations. Clients of the accounting firm may be allotted blocks of time to be used in consulting the various accountants. Thus, client A (which may be an organization) may be allotted 5 hours of consulting time and any time spent in consultation with any of the accountants of the accounting firm (and using the system) would be counted against that 5 hours of consulting time. Similarly, another client, an individual, may be allotted an hour of consulting time for an expert (employed by the accounting firm) in Panamanian tax law. For such an implementation, depending on the configuration of the system, the profiles of the supplier users (i.e. the subject matter experts) may be provided with a time rate (for those who are allotted consulting time on an ad hoc basis) or without a time rate (for those who are allotted blocks of consulting time). The system allows clients and organizations worldwide to thereby access expertise from a specific organization on a time basis.

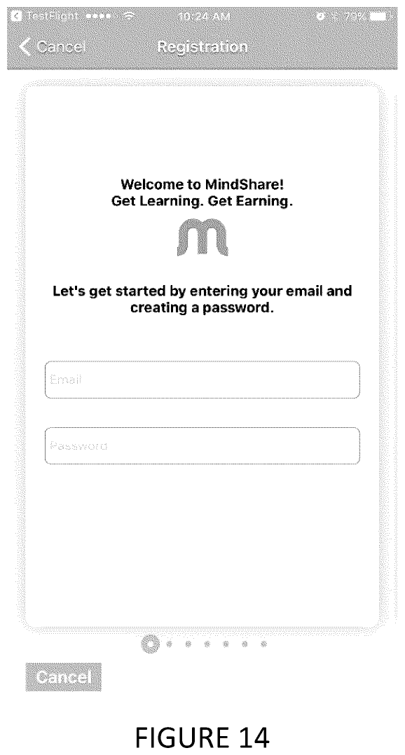

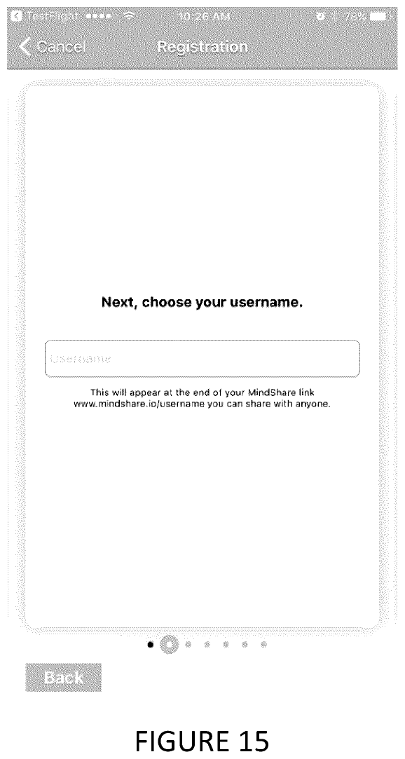

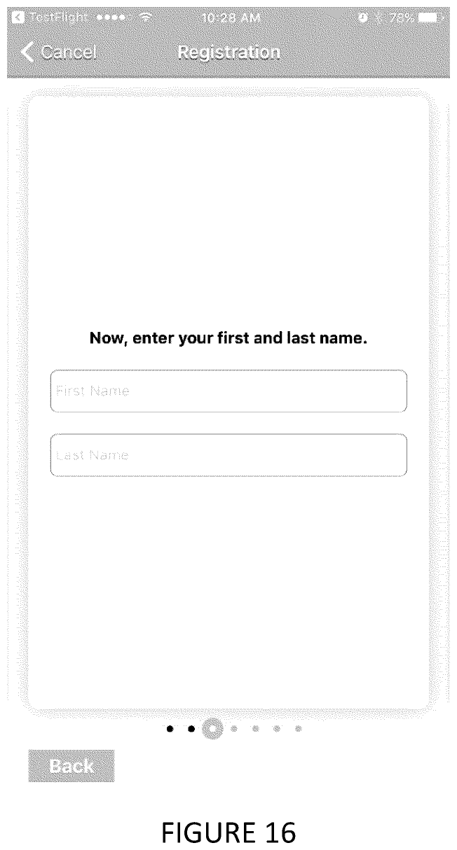

It should also be noted that the consumer user experience is also important to ensure wider acceptance for the system. To this end, the signup process for both consumer users and supplier users are, preferably, similar. FIG. 14 shows a landing page for starting the signup process. The user is queried for his/her email and password for use with the system. In the screenshot for FIG. 15, the user is queried for a unique username for use with the system. In the screenshot of FIG. 16, the user's real first and last names are requested.

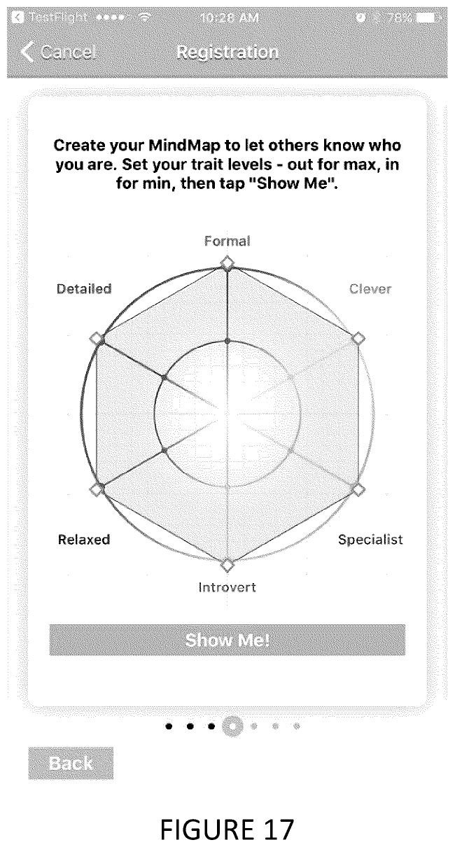

In the screenshot for FIG. 17, the user is requested to create a “mind map” or the user's own interpretation of what his or her personality and traits are. As can be seen, a wheel with a number of spokes is illustrated as part of the mind map. Each spoke on the wheel represents a personality trait or quality and the user can rate/rank his or her interpretation of how much of that trait he or she. As an example, for the trait “Formal”, a user can rate how formal he is by moving the marker on the spoke to be closer or further from the center of the wheel. The closer the marker is to the center, then the lesser the user feels he conforms to that trait. Thus, a casual (as in not very formal) user would move the marker to the innermost part of the spoke (i.e. place the marker at the center of the circle and farthest away from the perimeter of the surrounding circle). Similarly, a user who sees himself or herself as being very formal would place the marker at the very edge of the perimeter of the surrounding circle. It should be clear that although FIG. 17 shows traits to be ranked as “Formal”, “Detailed”, “Clever”, “Relaxed”, “Introvert”, and “Specialist”, other traits may also be used.

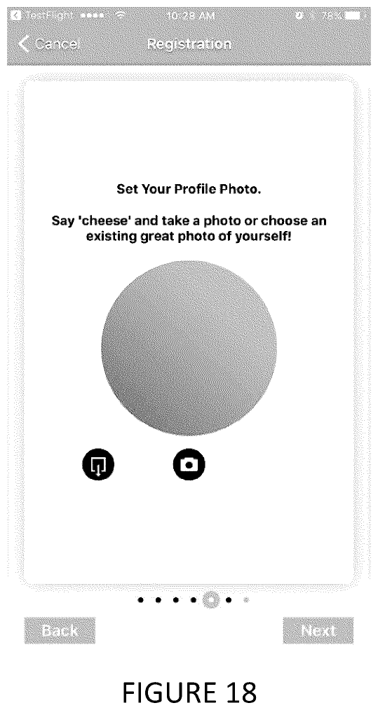

In FIG. 18, the user is prompted to provide a suitable profile photo or the app may take a photo of the user to be used as a profile photo.

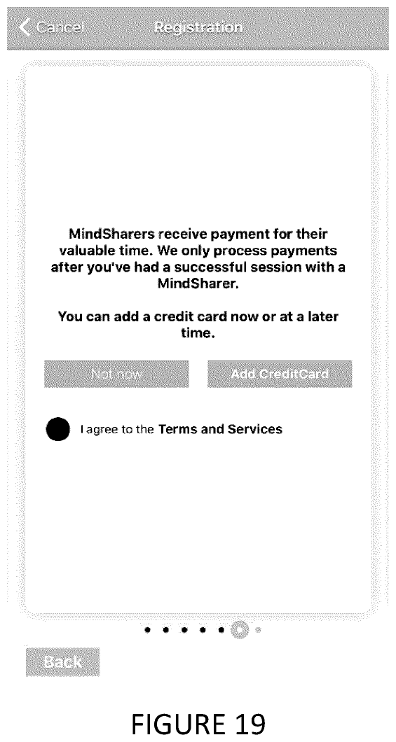

For FIG. 19, the user is given the option of adding a credit card during the registration process. This allows the user to activate his or her account and start searching for consumer users. Of course, as noted in the Figure, the user may opt to add a credit card at a later time.

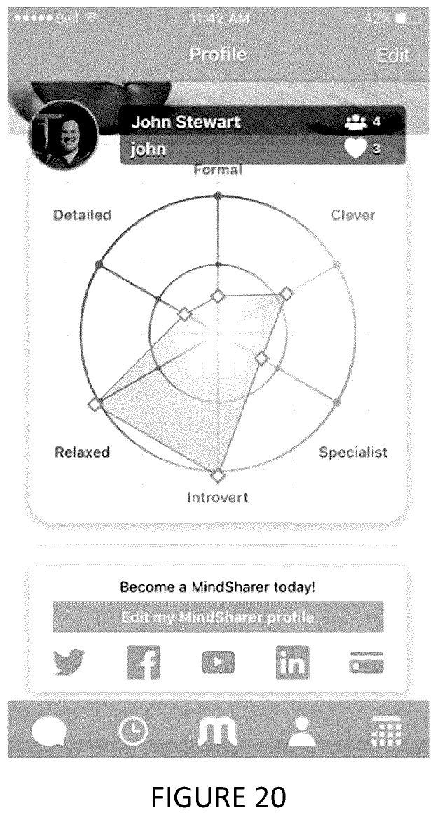

Once the user has been registered, a profile page is created for the user. As can be seen from FIG. 20, this profile page for the consumer user includes the user's mind map, his name, and profile picture.

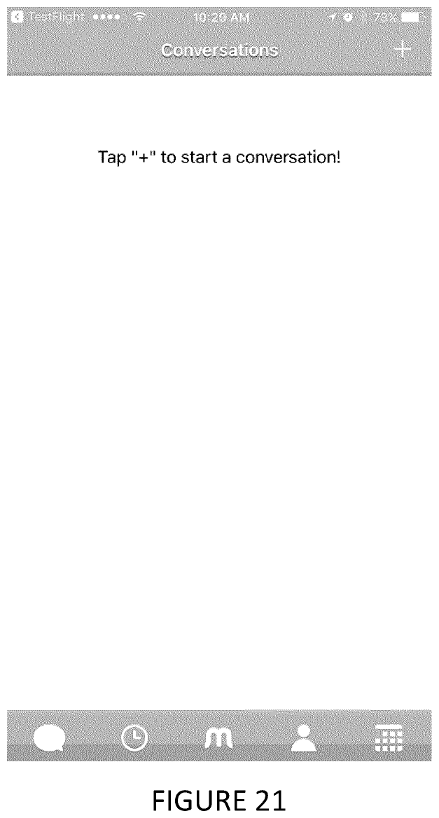

To start interacting with other users, the consumer user merely has to tap the “+” button in the conversations pane of the user interface (see FIG. 21).

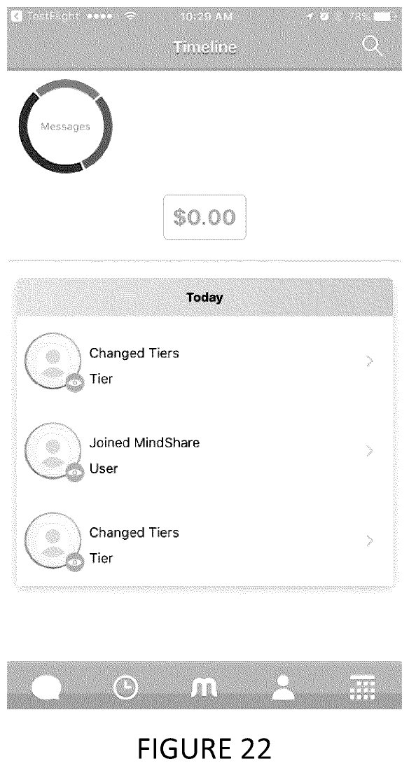

The new user's activities are summarized in his timeline page (FIG. 22). As can be seen, the user does not have any messages pending, has not earned any money, but has joined the system and has changed membership tiers.

Regarding the tiers, it should be noted that, in one implementation, the system may be configured to have multiple tiers for users, with each tier having different capabilities and benefits. As an example, the lowest tier may be for non-members to allow non-members to take a tour and view the different features of the system. The next tier would be for consumer users only—users who do not provide expertise to others and who only consume expertise. The next tier may be the lowest tier for supplier users—users who provide expertise to consumer users and who may also be consumer users themselves. For this lowest tier of supplier users, the supplier user is only allowed to charge up to a preset maximum per minute charge (e.g. $1.00 per minute). For this lower supplier user tier, the supplier user can set a charge per time unit that does not exceed a preset limit. A supplier user can move up to the next tier once he or she has achieved a milestone that may be linked to however many time units of expertise he or she has provided. As an example, from the tier 1 supplier user (i.e. the lowest tier for supplier users), a supplier user can only charge a maximum of $1.00 per minute. To reach tier 2, a supplier user must provide, for example, 10 hours of expertise. This means that a supplier user who has provided 10 hours of expertise to consumer users, whether through live audio, live video, pre-recorded video, or live text, can be promoted to tier 2. The higher tier means that the supplier user now has a higher maximum charge per unit time. Instead of only being able to charge a maximum of $1.00 per minute under tier 1, the supplier user can now charge a maximum of, for example, $2.00 per minute for his expertise. It should be clear that the number of tiers in the system, the maximum charge per unit time for each tier, and what may be required to be promoted to higher tiers, are all implementation dependent.

It should also be clear that the system may include a celebrity tier. This tier, preferably, has no limits in terms of how much a supplier user can charge and, generally, has limited or minimal restrictions. As well, supplier users in the celebrity tier do not have to start at the lower tiers to be able to reach the celebrity tier—specific supplier users can be awarded the celebrity tier level by the system operators without having to go through the other tiers. The concept behind the celebrity tier is that it allows the system operators to offer incentives to celebrities to use the system and be used as an expertise resource by the consumer users. As an example, a celebrity chef may sign on and may provide expert guidance/expertise to consumer users who want to learn about, for example, creating a perfect soufflé. The celebrity tier would allow the celebrity supplier user to offer, for example, a specific one-time per viewer charge for a closed session. Thus, a well-known builder/contractor (e.g. Mike Holmes) may charge each viewer $100 for a session on how to renovate a kitchen.

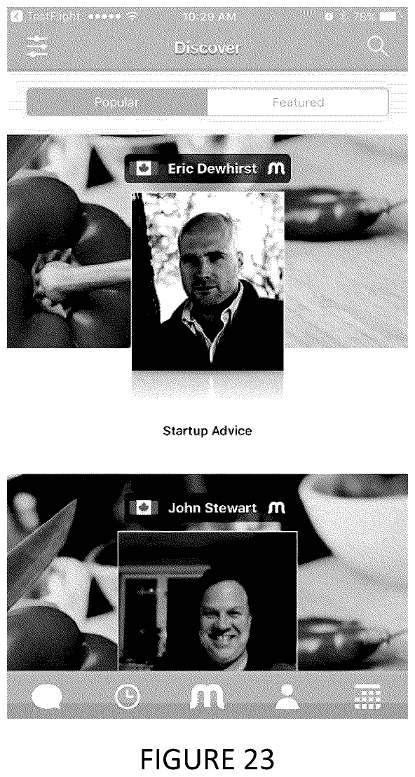

Returning to the user experience, FIG. 23 illustrates a user interface for when the user wishes to view popular supplier users. As can be seen, the user simply has to click the “POPULAR” button in the “Discover” pane and the system provides the user with the profile pictures, names, and fields of expertise for the most popular supplier users. A user can then click on these specific supplier users to learn more or to schedule an appointment or interactive session with these supplier users. It should be clear that, in one implementation, a supplier user can be designated as a “POPULAR” supplier user if at least a predetermined number of consumer users have viewed or followed that particular supplier user's public profile during a specific time period (e.g. a specific day, week, month, etc.). Thus, as an example, a specific supplier user may be designated as “Popular” if 100 consumer users have viewed or followed that supplier user in the past 24 hours (assuming that the predetermined time window is 24 hours and the “popularity” threshold is set at 100 views/follows). Of course, if that same supplier user has NOT had 100 views/follows in the last 24 hours (even if he had 1000 views/follows last month), the that supplier user would not be listed in as a “popular” supplier user.

Once a user has followed at least one supplier user, a third option, “FOLLOWING”, appears in the DISCOVER pane. This option is in addition to the options “POPULAR” and “FEATURED”. Clicking this option gives the user easy access to the supplier users that the user is following in a user interface that is similar to that for the POPULAR supplier users. For ease of access to the profiles and other associated data for these popular or featured supplier users, the system can cache the data for these specific supplier users on each consumer user's device. This allows faster access to such data and reduces the need for frequent data access calls to the database and to the servers. To ensure that the most up-to-date data is properly cached, the data is time-stamped and that data is automatically refreshed after a set period of time (e.g. refreshes every hour).

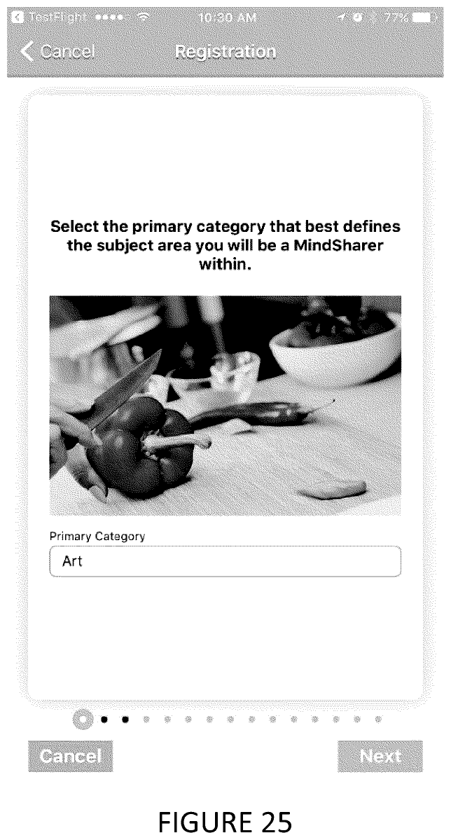

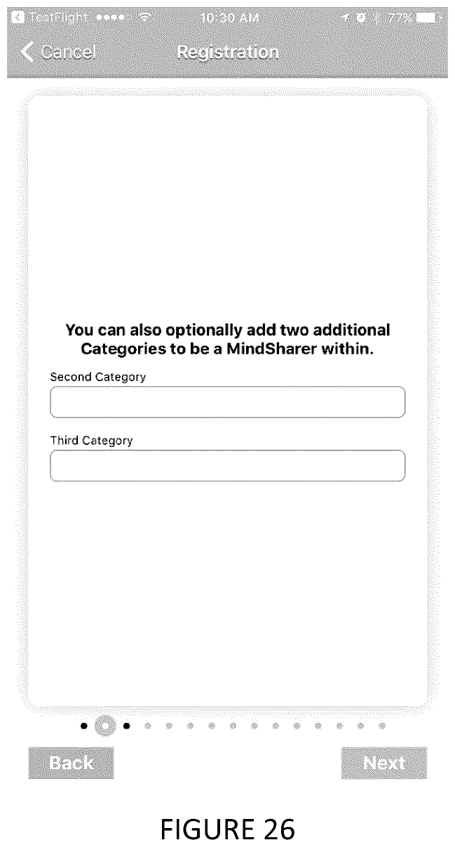

To register as a supplier user, the user has to enter a number of categories under which the user's expertise may be classified. FIGS. 25 and 26 show user interfaces where the registering user is prompted to provide a total of three categories regarding the user's expertise. Other implementations that allow for more categories are, of course, possible.

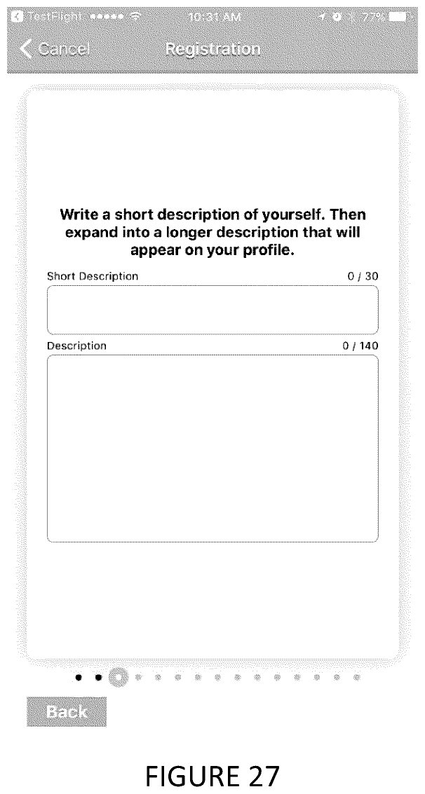

Once the registering supplier user has provided three categories for his or her expertise, the user is then prompted to compose descriptions for supplier user and/or the expertise to be provided. These descriptions will form part of the supplier user's profile. (FIG. 27)

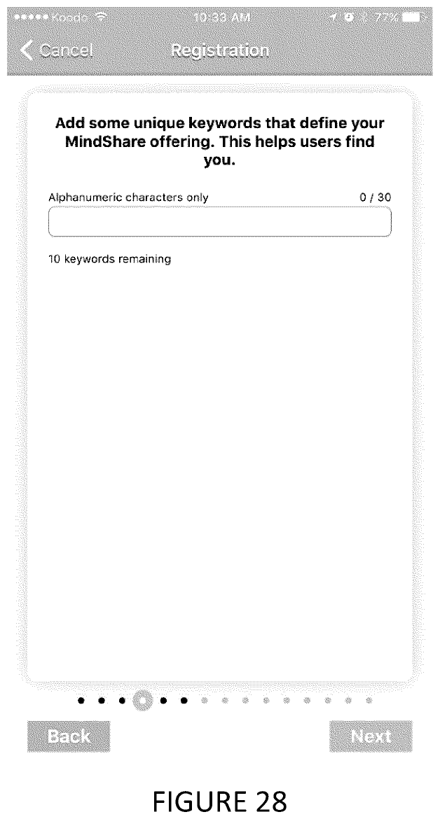

With the descriptions composed, the registering supplier user is then prompted to provide multiple keywords relating to the expertise being provided as well as to the supplier user himself. The keywords will be associated with the supplier user's profile and will help consumer users to find the supplier user. (FIG. 28)

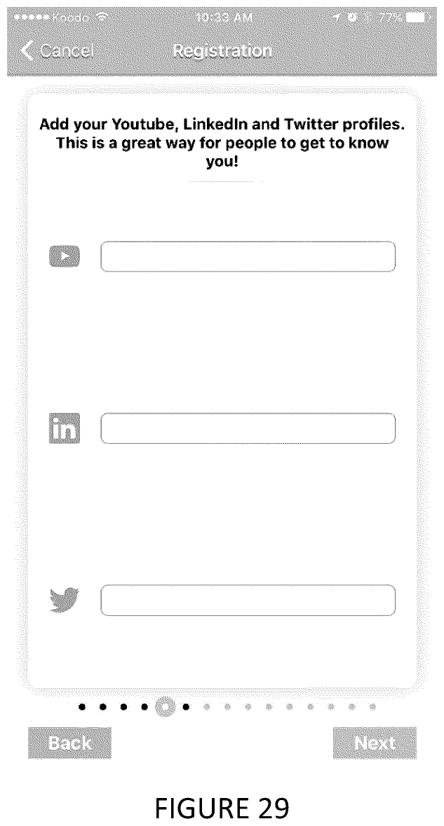

To further assist the consumer user, the registering supplier user may enter links to the supplier user's profiles on other social media platforms such as YouTube™, LinkedIn™, and Twitter™. These links will form part of the supplier user's profile and consumer users seeking more information on the supplier user can consult the supplier user's profiles on these platforms (FIG. 29).

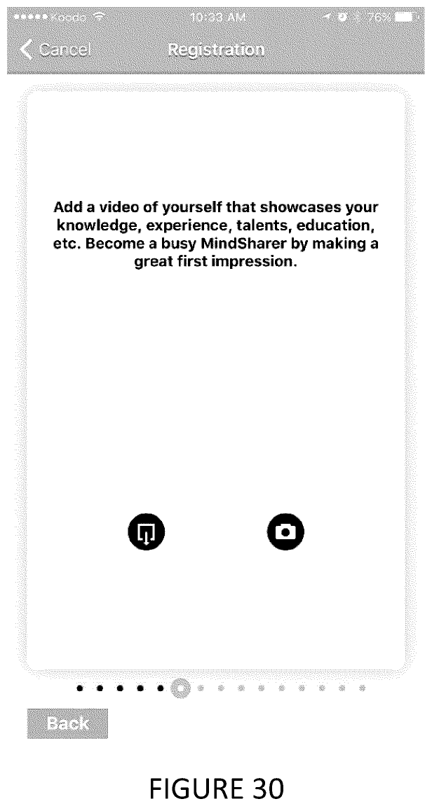

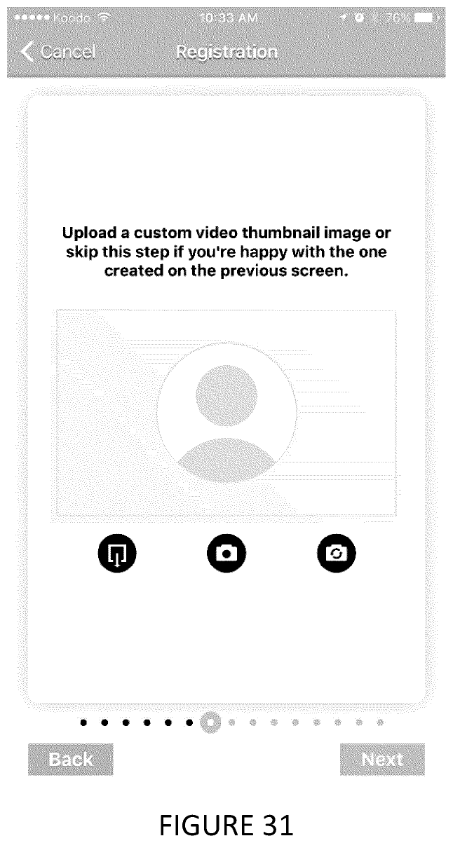

The registering supplier user may also upload a video showcasing the supplier user's expertise or personality to entice consumer users to schedule interaction time with the supplier user (FIG. 30). Similarly, a video profile image may be uploaded to give the supplier user an option to use a different profile image for the video (FIG. 31).

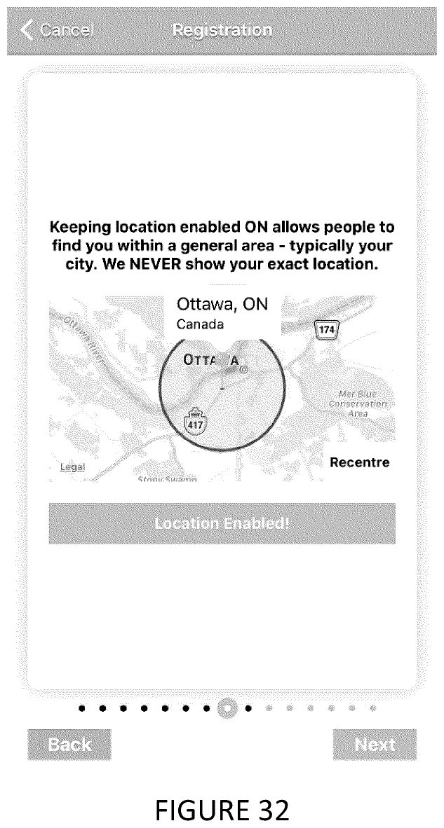

In FIG. 32, the registering supplier user can also indicate his or her location to consumer users. The location function allows consumer users to keep track of the general area where the supplier user is located. To address the supplier user's privacy concerns regarding location, the system may use reverse geocoding lookups to find the nearest city/town to the registering supplier user's location. This nearest city/town is then the location shown in the supplier user's publicly available profile.

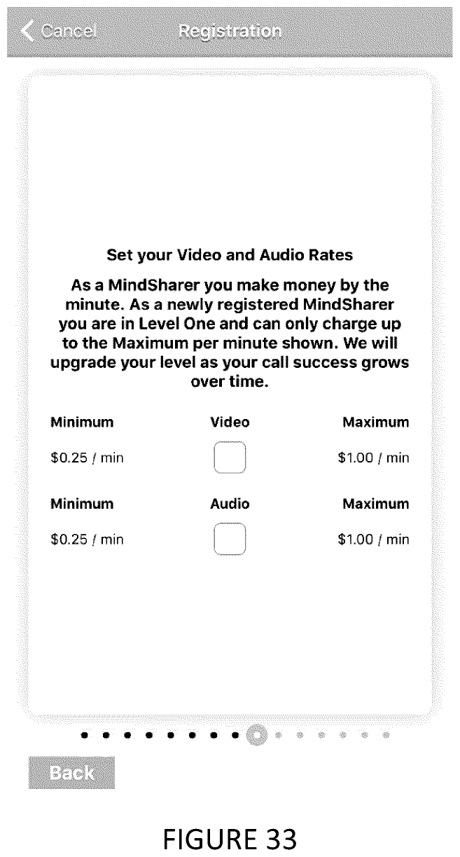

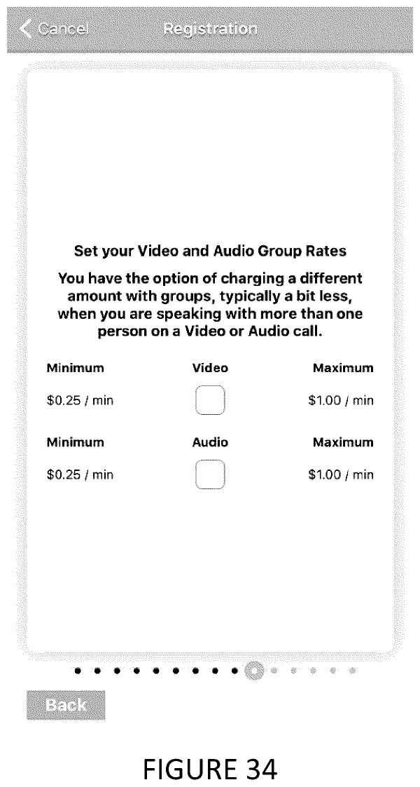

In FIGS. 33 and 34, the registering supplier user is prompted for individual and group rates for audio and video interactions with consumer users. As can be seen, minimum and maximum charge rates apply. It should be noted that, in this instance, since the supplier user is new (i.e. the supplier user is just registering), then the supplier user is at the lowest tier for supplier users. As such, a low maximum charge rate is active. Once the supplier user has moved to higher tiers, the supplier user can charge higher rates.

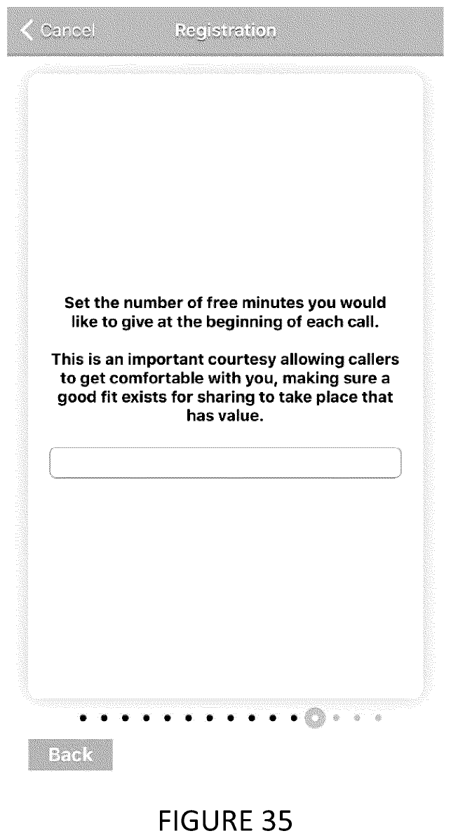

In the user interface illustrated in FIG. 35, the registering supplier user is prompted for the number of free minutes he or she can provide to consumer users.

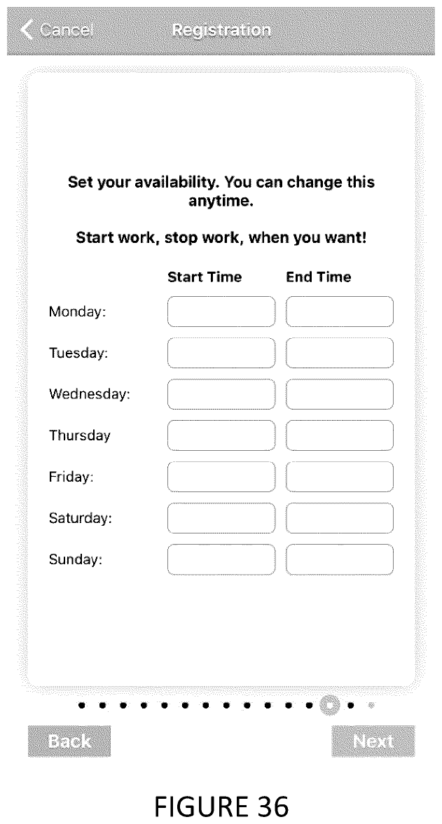

Once the registering supplier user has provided the details regarding charge rates, the supplier user can provide details about his or her availability. Of course, as noted in FIG. 36, the supplier user can adjust/change this availability schedule.

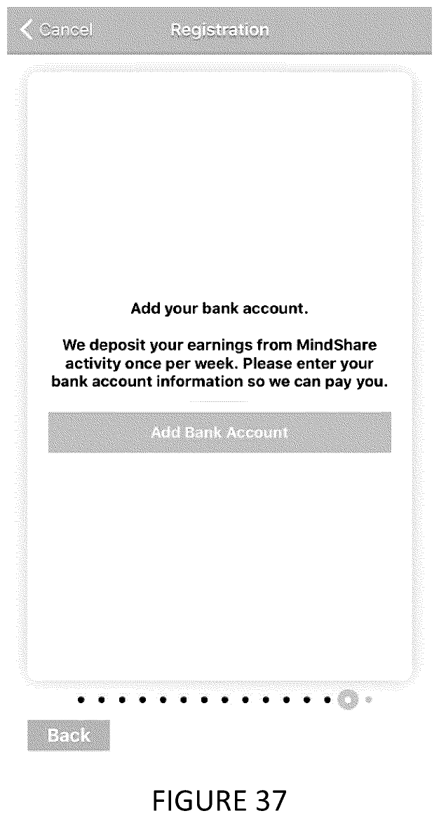

To assist in the transfer of funds to the registering supplier user, the supplier user is prompted to add bank account details in FIG. 37. It should be noted that, in one implementation of the system, supplier users are paid by bank transfer directly to the supplier users' bank account. Conversely, consumer users pay by way of their credit cards.

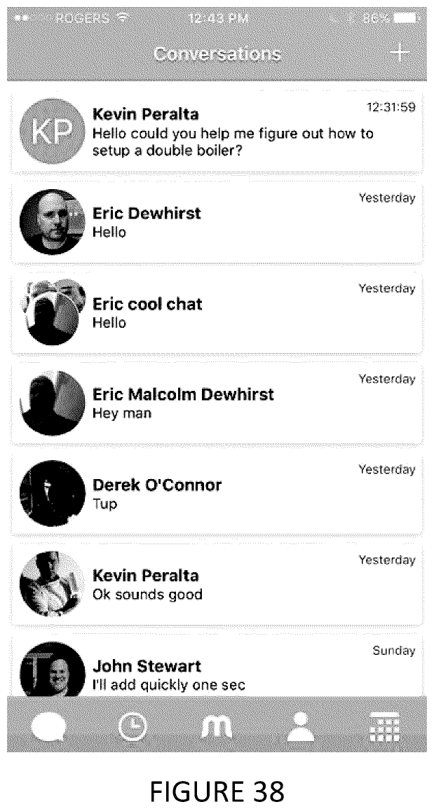

After a user has registered and a profile has been created for that user, the user can interact with other users. As an alternative user interface to the user interface in FIG. 10, FIG. 38 details a user's conversations, the last entry in each conversation, the date of the conversation, and a name and profile picture for the user on the other side of the conversation.

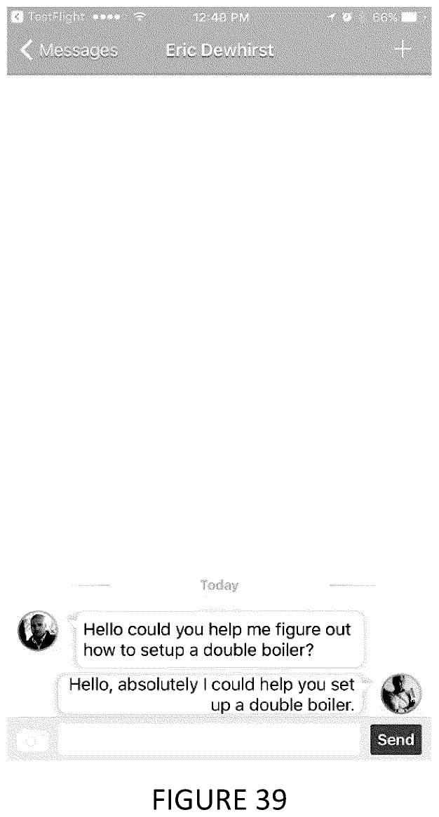

Once a conversation with another user has been initiated, a chat or conversation window, similar to that illustrated in FIG. 39, can be opened.

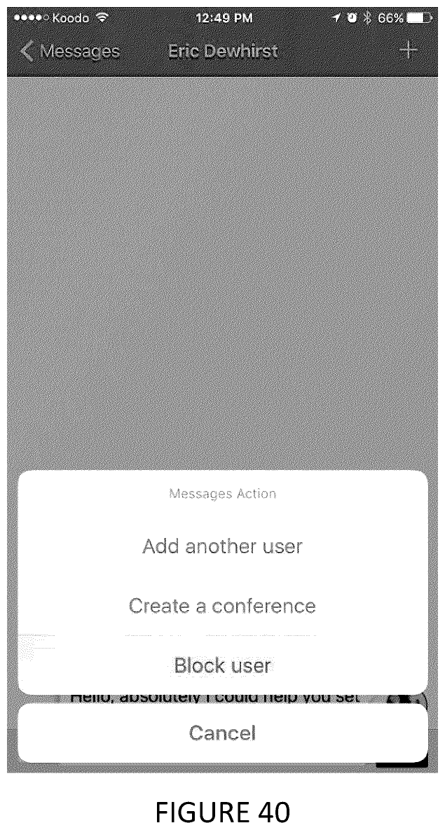

Inside the conversation window, users can add another user to the conversation, create a conference (i.e. a one-on-one interaction between a supplier user and a consumer user), or the user can block the person on the other side of the conversation (FIG. 40).

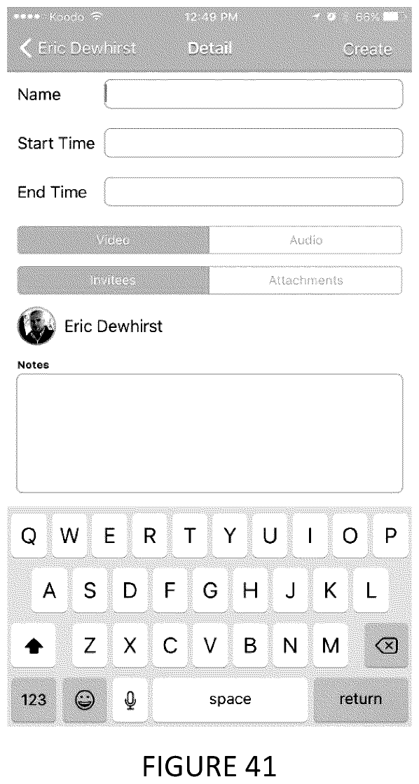

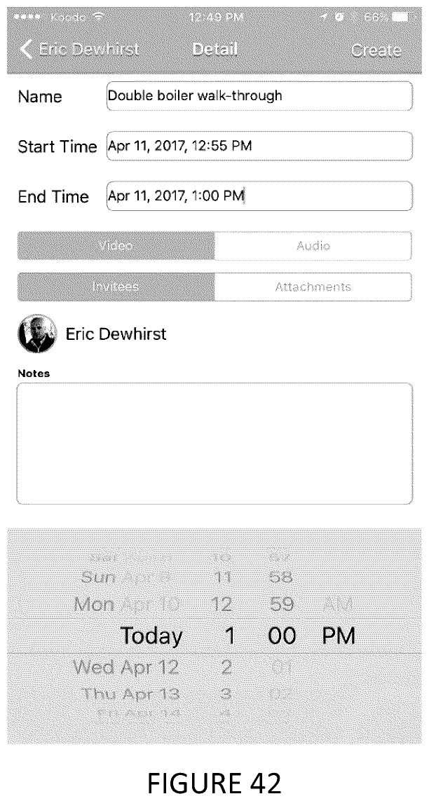

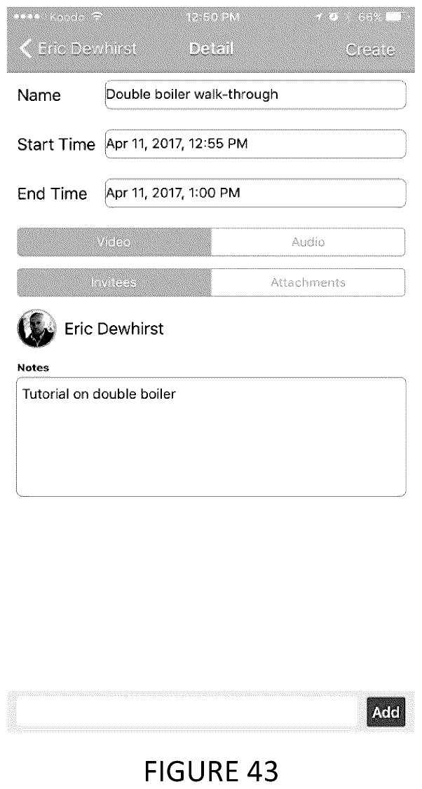

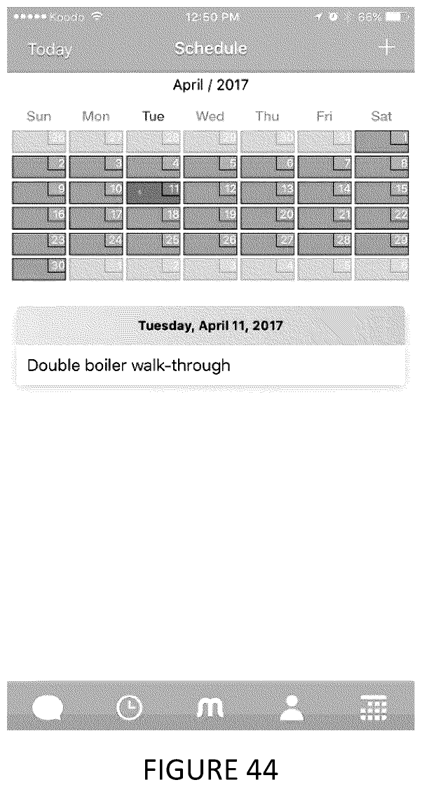

Once the supplier user has accepted a consumer user's request for a conference (as detailed in the conversation in FIG. 39), the supplier user can enter the details regarding the agreed upon conference. In FIG. 41, the supplier user is prompted for the details regarding the conference. The consumer user is identified, a name for the conference is prompted for, and start and end times for the conference are to be entered. As well, the type of conference (video or audio) is detailed, and the invited users (in this case the consumer user) are identified. To assist the supplier user, entering the start and end times may cause a drop down or a scroll down menu to appear so that the supplier user can easily enter dates and times (FIG. 42). In FIG. 43, the final form of the conference being created is presented. The calendar entry for this conference is then created in the supplier user's calendar in FIG. 44.

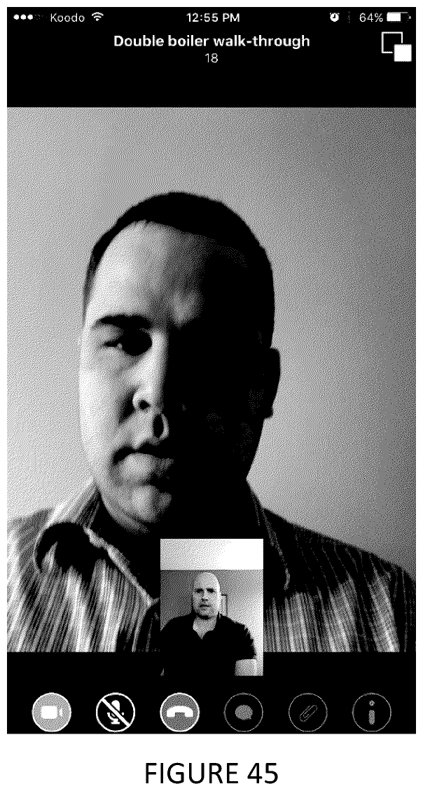

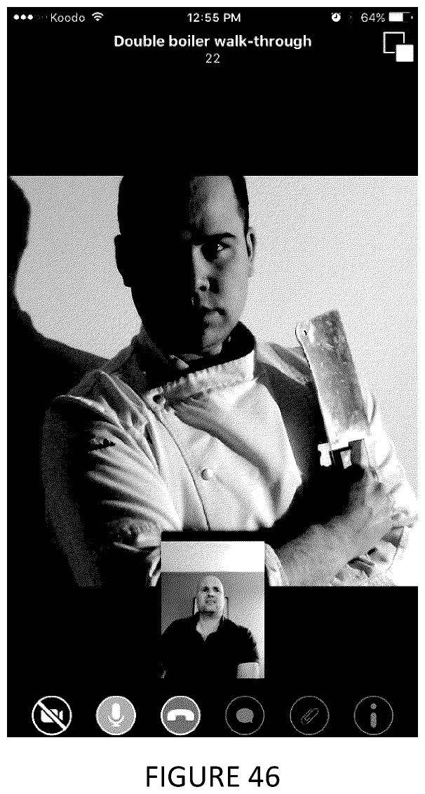

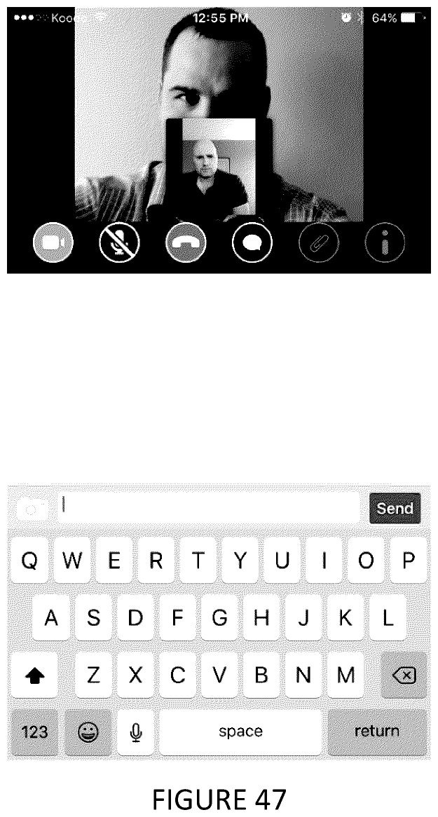

Referring to FIGS. 45 to 47, the different options for a video conference between a supplier user and a consumer user are illustrated. In FIG. 45, both the supplier user and the consumer user are live with a live video feed for both using their respective device cameras. In FIG. 46, the supplier user has opted to not use his device camera and, as such, a static image for the supplier user is used in the video conference. The consumer user, on the other hand, presents a live feed using his device camera. In FIG. 47, instead of both an audio and a video feed between the two users, the supplier user can mute the audio feed and, instead, type out messages to the consumer user.

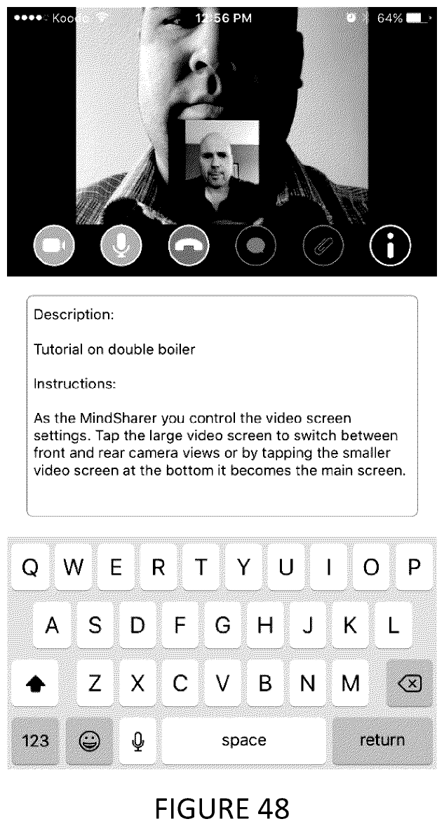

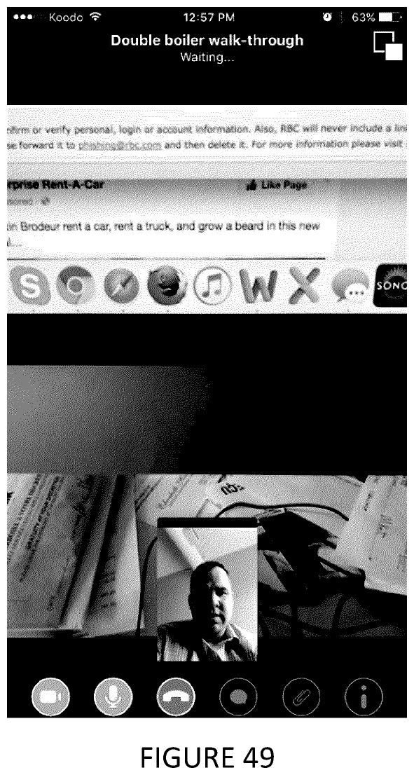

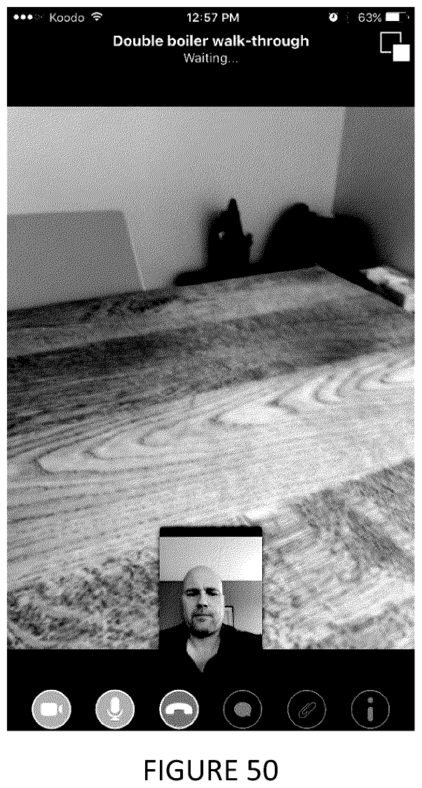

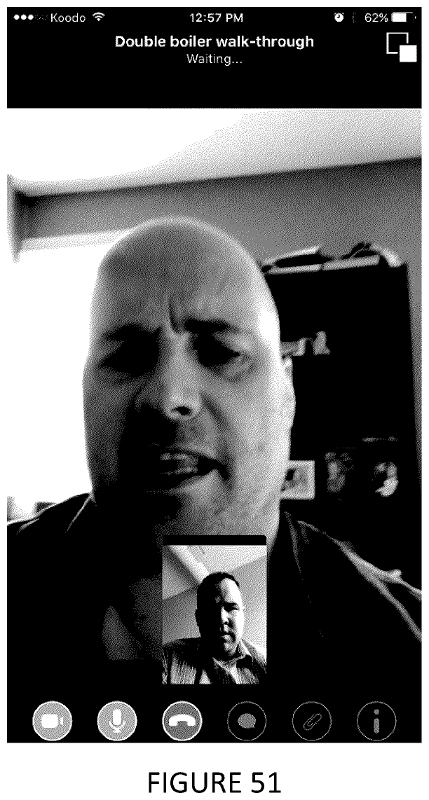

It should be clear that the supplier user has control over the feed views. To this end, the supplier user can control which of his device cameras are active. Thus, front camera on his device can be active to show the supplier user on the video conference or, if the supplier user wishes to show something to the consumer user, the back camera may be activated. (See FIG. 48) One example of this is provided in FIG. 49 where the supplier user's back camera is active and its feed provides the backdrop to the video conference. When the back camera of the device is active, the supplier user's front camera feed is in the smaller video window on the user interface. Conversely, the video conferencing can be configured so that the consumer user's front camera is active so that the consumer user can provide the supplier user with a view of what the consumer user is viewing. When this occurs, the consumer user's front camera feed is placed in the smaller video window (see FIG. 50). Of course, the supplier user may opt to have the consumer user's video feed to be in the larger video window while the supplier user's video feed is in the smaller window (see FIG. 51).

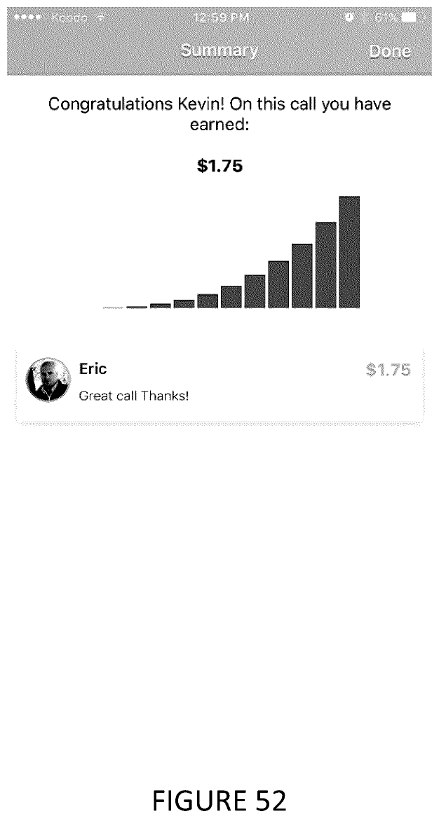

Once the video conference is over, a summary screen is presented to the supplier user. This summary screen (seen in FIG. 52) details how much the supplier user earned for the call as well as any feedback the consumer user may have provided for the conference.

It should be clear that although the Figures show a simple real-time online video call, other calls and interactions between consumer users and supplier users are possible. As an example, group calls, whether audio or video, are possible with multiple consumer users simultaneously receiving a video feed from one or more supplier users. This allows single supplier users to essentially run video seminars or for multiple supplier users to partner together and run multi-participant seminars. As well, instead of just showing the supplier user in the video call, supplier users can share their screens with the consumer user to facilitate explaining the subject matter or to show something that might be germane to the subject at hand. As an example, a supplier user teaching a consumer user about grilling a steak may show the consumer user a perfectly grilled medium rare steak so that the consumer user can see the required pinkness of the meat. Similarly, a supplier user explaining how to solve a particular algebraic problem can show the consumer user a whiteboard that details the steps in the solution.

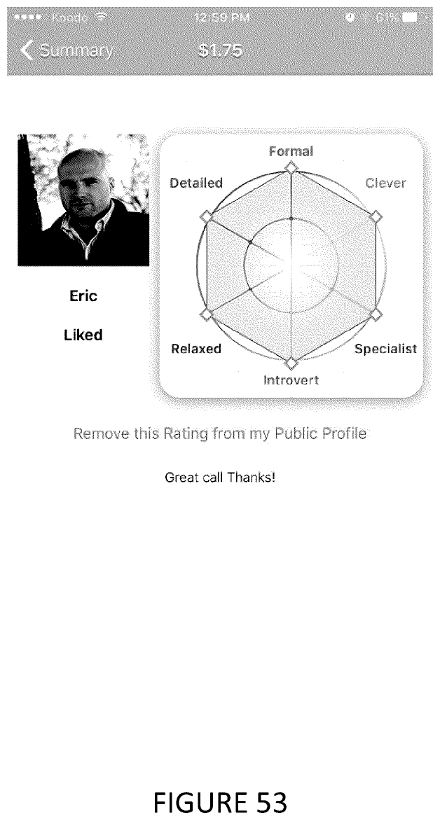

The consumer user feedback for the conference can be viewed by the supplier user and may take the form as illustrated in FIG. 53. As can be seen, the consumer user can leave a text feedback as well as a mind map ranking. The mind map ranking allows the consumer user to rank the supplier user based on the categories listed in the mind map.

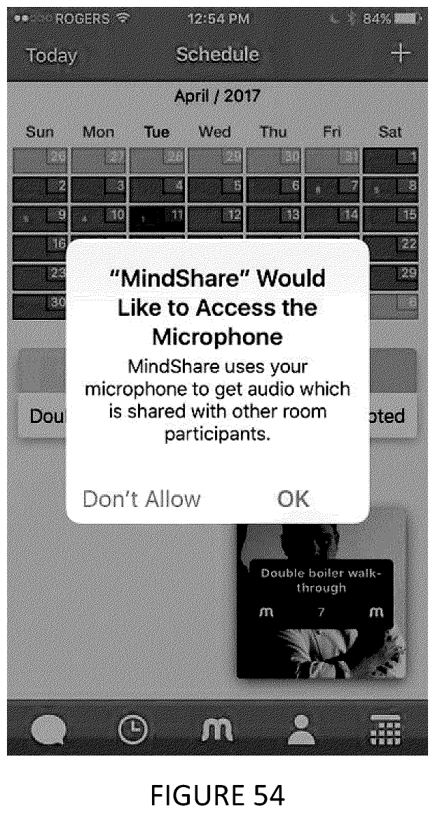

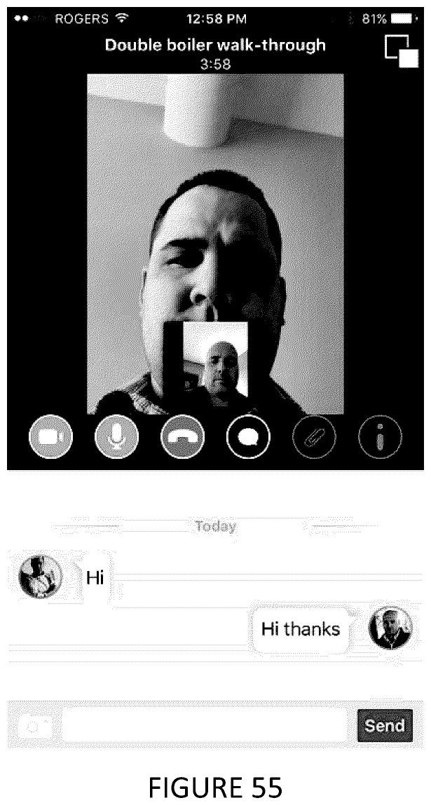

For the consumer user, the experience when participating in a video conference can be as shown in FIGS. 54-58. In FIG. 54, the consumer user is prompted to provide access to the user's device's microphone so that the user's audio can be shared with the supplier user. In FIG. 55, the consumer user is provided with the video conference user interface. In this interface, the supplier user's video feed is in the larger video window while the consumer user's video feed is in the smaller video window. For this interface, the two users are communicating via text messaging. It should be clear that group text messages are also possible. As such, text messages to groups of consumer users or to groups of supplier users or to groups of mixes consumer and supplier users are possible.

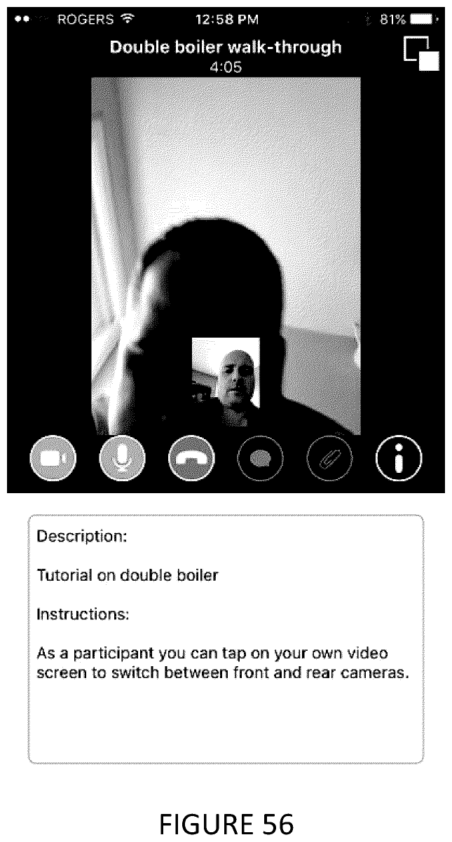

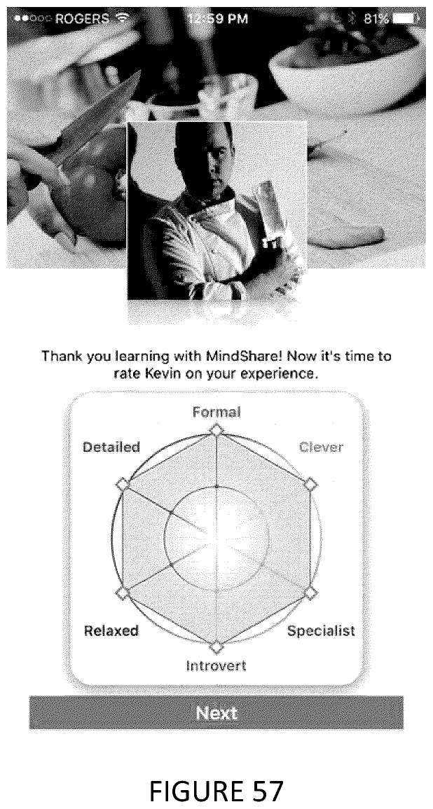

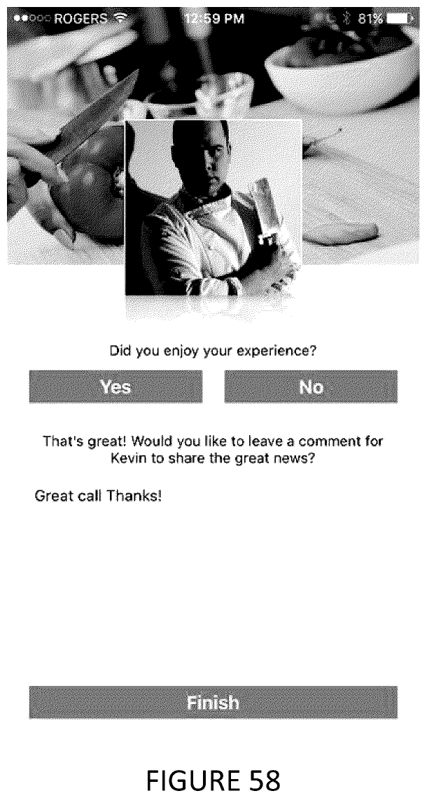

In FIG. 56, the consumer user is provided with options as to which device cameras to activate. Once the video conference is over, the consumer user is provided with the option to leave feedback regarding the supplier user. As noted above, the consumer user can provide feedback by providing a mind map of the supplier user (see FIG. 57) and, as shown in FIG. 58, by providing a text based note on the video conference.

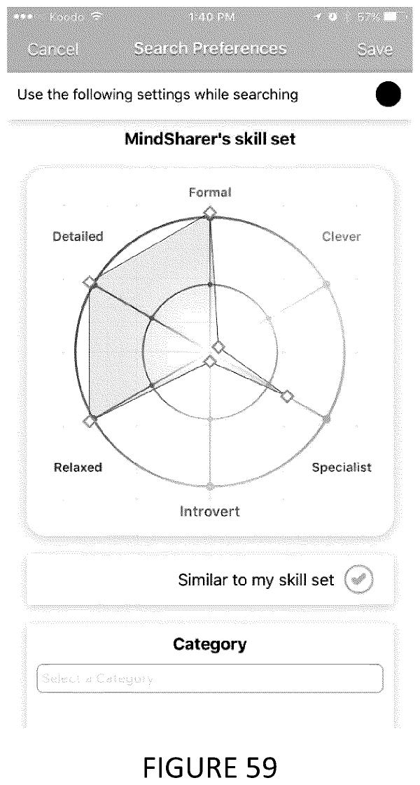

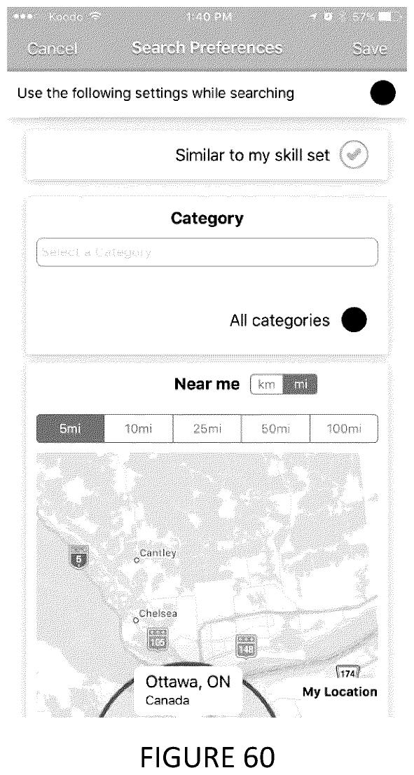

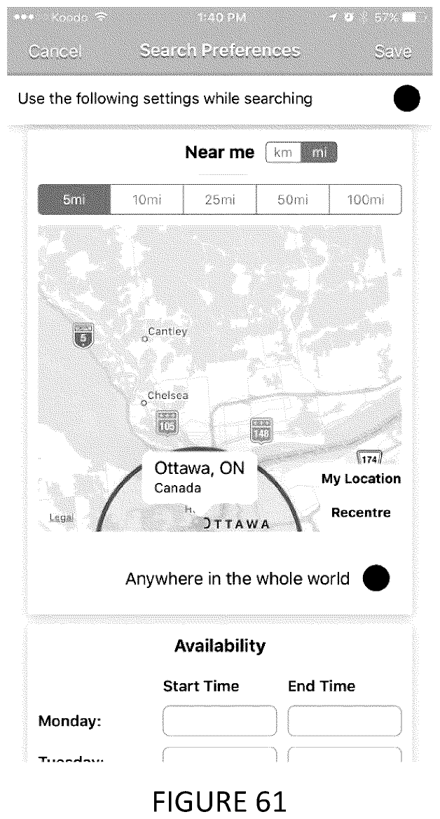

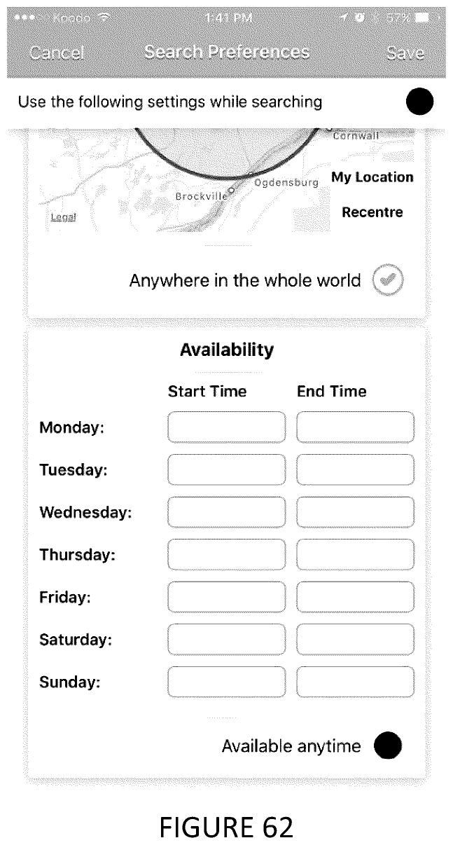

For the consumer user, searching for a supplier user may include searching for someone with a specific skill set or a specific personality/characteristic trait set. In FIG. 59, the consumer user may detail, using a mind map, the skill set sought for a specific supplier user. Or, as shown in FIG. 59, the consumer user may take a shortcut and simply detail that the supplier user sought has to have the same skill set as the consumer user. The consumer user may also constrain the search for supplier users who are located in a specific locale or vicinity. In FIG. 60, the consumer user, in addition to noting that the supplier user has to have the same skill set as the consumer user, also has to be near the consumer user. In FIG. 61, the consumer user enters the location constraints for searching for supplier users. As can be seen in FIG. 61, the consumer user can search for supplier users that are within a certain distance from the consumer user. Finally, in FIG. 62, the consumer user can constrain the search to supplier users who are available at specific times and specific days.

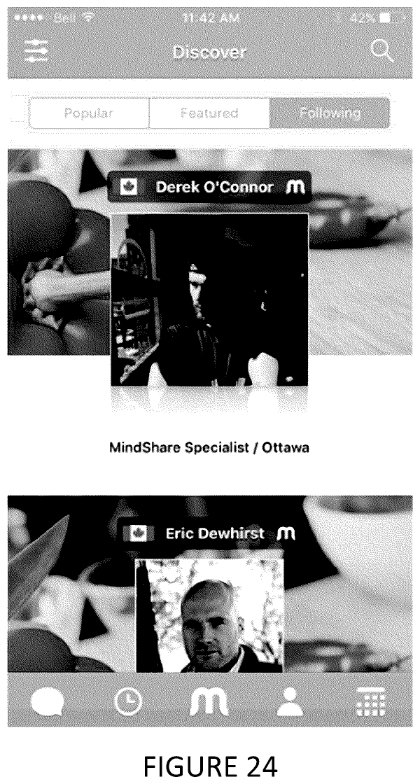

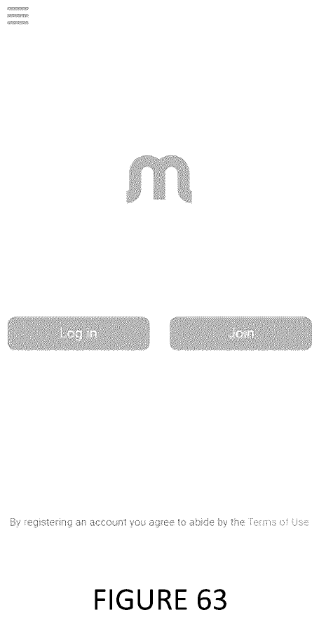

It should be clear that while FIGS. 14-62 illustrate screenshots of one implementation of one aspect of the present invention, other implementations that embody the same or similar concepts are also possible. Referring to FIGS. 63-94, screenshots of another implementation of the present invention are presented. It should be clear that FIGS. 14-62 and 63-94 only provide selected screenshots of different implementations of the present invention and are not intended to illustrate a complete user experience or a complete set of user interfaces for either implementation.

In FIG. 63, a mobile device page for a system implementing the present invention is illustrated. As can be seen, the page prompts the user to login to the system or to register and join. Previous pages may present the user with the benefits of joining and registering on the system while unobtrusively prompting the user with the login or join prompts.

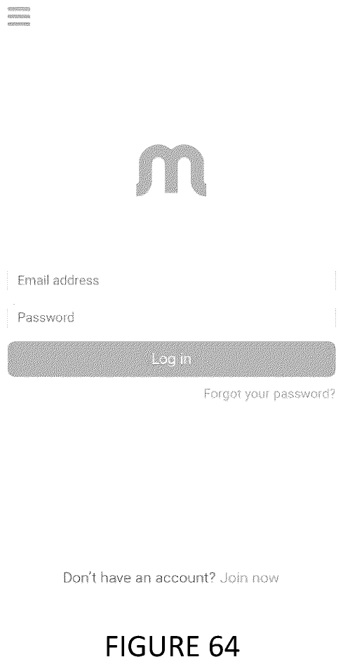

FIG. 64 provides the user with a login page that prompts the user for his/her email address and password for the system.

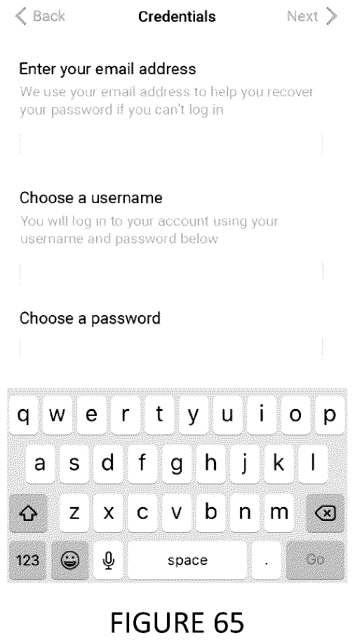

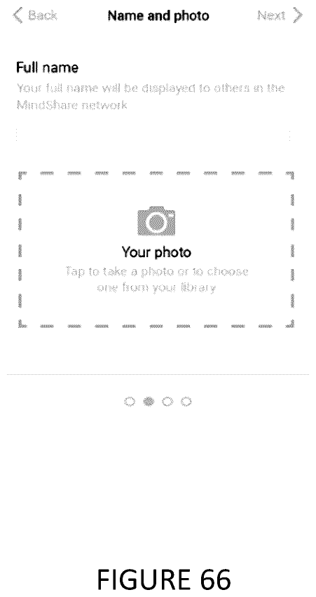

FIGS. 65-68 are registration screens that correspond to the registration screens in FIGS. 14-16. As can be seen, instead of breaking up the user registration process with one screen for the user's email address and password and another screen for a username, FIG. 65 shows that the user is prompted for his email address, username, and password in a single screen. Similarly, FIG. 66 prompts the user in a single screen to enter his full name and to provide a photograph for his profile picture. In contrast, in FIGS. 16 and 18, the user is prompted in different screens for his full name and photograph.

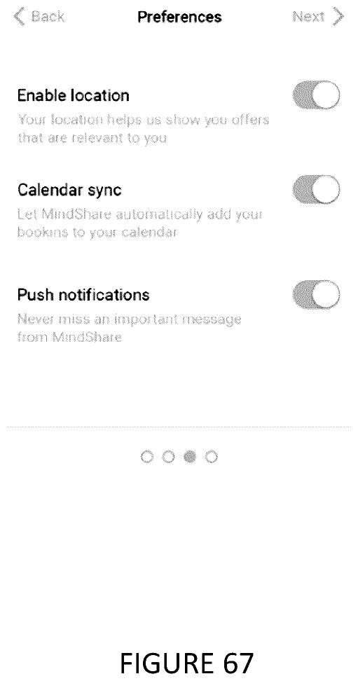

FIG. 67 provides the user with options to turn on/off a number of preferences for his profile. As can be seen, the user can choose whether his location is made available to the system, whether his calendar in the system is synchronized with his calendar on the mobile device, and whether the system is allowed to send him push notifications.

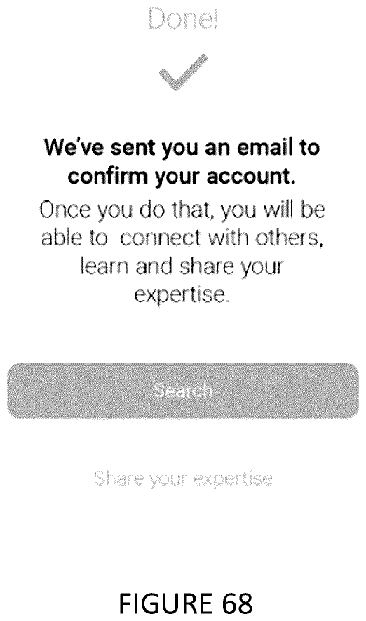

Once the user has finished registering with the system, FIG. 68 notifies the user that a confirmation email has been sent to his registered email address. Once the user accesses that confirmation email and confirmed that the email address is, indeed, his, then the user can continue to use the system as a registered user.

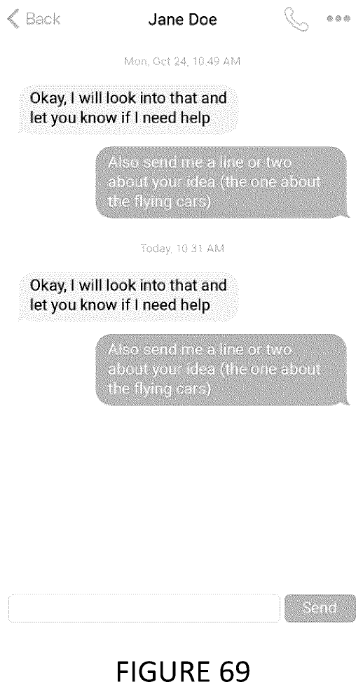

FIG. 69 illustrates a user interface for viewing and/or interacting with another user using an online real-time messaging system. As can be seen, in contrast with the implementation illustrated in FIGS. 9-12A, the user interface in FIG. 69 has a cleaner look and the menu at the bottom of the screen has quick access icons at the bottom of the screen has been dispensed with. The online messaging user interface in FIG. 69 is similar to the user interface in FIG. 39. However, in contrast to the user interface in FIG. 39, the user interface in FIG. 69 does not use icons or profile pictures of the users involved in the online conversation.

In one variant of the present invention, the data entered into the online messaging interface can be mined to assist the users. Chat bots or automated processes that monitor the various conversations being held across the system can be used. These bots would then analyze the entered data for patterns and specific keywords. Once specific patterns and keywords are found, specific actions can then be launched by the bots. As an example, if a keyword “appointment” or “schedule” is encountered, the bot can check the calendars of the users conversing and can find a time slot suitable for both users. Both users are then prompted if they want to schedule an appointment for that time slot.

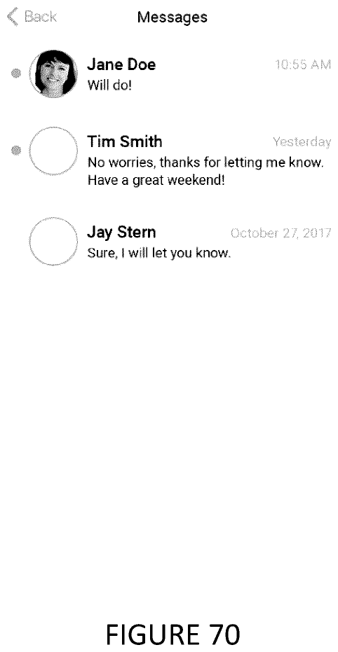

Referring to FIG. 70, a user interface for presenting the user with all the ongoing conversations or messages he may have is presented. As can be seen, in contrast to a similar user interface in FIG. 38, the quick access icons at the bottom of the screen have been removed. As well, unread messages in the user interface in FIG. 70 are marked with a dot next to the message or conversation.

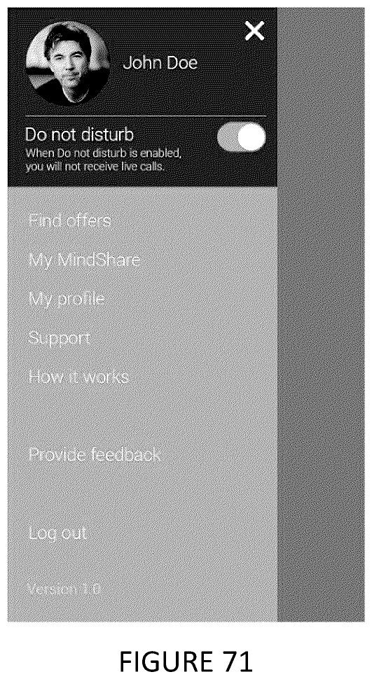

In FIG. 71, a user menu interface is presented. The menu is a quick access menu for a supplier user. As can be seen, the menu allows the supplier user to turn on/off a DO NOT DISTURB option. This allows the supplier user to use the system without fear of being disturbed by incoming calls from other users. Similarly, the menu allows the supplier user to search for offers from consumer users. The supplier user's profile can easily be accessed through the same menu as well as support from the system operators. In case the supplier user has questions about the system, a “How it works” option, similar to a FAQ section, is available. Of course, the menu also provides the user with a quick means to provide feedback regarding the system and the experience as well as a quick means to logout of the system.

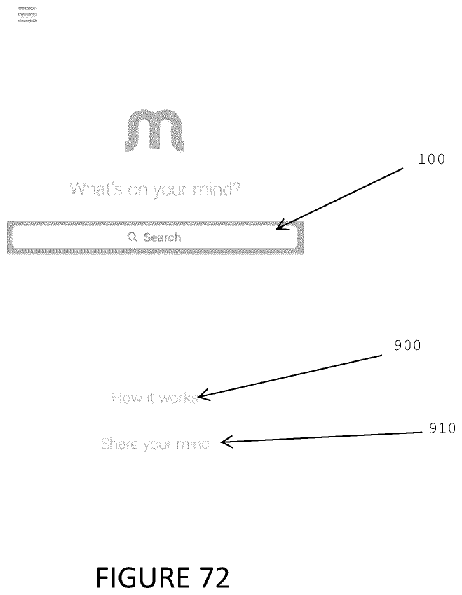

Referring to FIG. 72, a search page is provided. The search page in FIG. 72 operates as an alternative to the query/search page illustrated in FIG. 2. As can be seen, a cleaner user interface is provided in FIG. 72. A search/query box 100 is provided as well as prompts for links 900, 910. Link 900 would provide the user with an explanation of the system while link 910 would provide the user with the means to become a supplier user.

It should be noted that the searching function may have different capabilities based on the implementation. In one implementation, searching for keywords also involves searching for those same keywords in the supplier users' description or profiles. Preferably, the search engine used takes into account the different languages which may be used in the profiles. As another variant, the searching may involve fuzzy logic searching. As is known, fuzzy logic searching involves measuring the Hamming distance between the keywords being searched for and the terms encountered while searching. This capability would allow for typographical errors in the search query and still accurately find supplier users relevant to the consumer user's search. In another variant, the searching feature would provide suggestions for the consumer user's search. Such a search system would use past search queries from other consumer users to autocomplete search terms as a consumer user is typing the search terms. In one implementation of this variant, every search conducted by a consumer user is stored and this database of searches is analyzed and the results are clustered to result in a cache set that will be the basis for the recommendations/suggestions. Other suggestions may also be made to the consumer user using machine learning techniques. These techniques would be used to analyze past queries from other consumer users and, based on the analysis, recommendations and suggestions are made about what the specific consumer user may be interested in based on the search query patterns from other consumer users. This may be implemented by parsing the anonymized search queries into analyzed sets of data which can be taken to internal machines and processed to generate the necessary model. Software libraries such as CoreML may then be used run the data locally on the consumer user's device to make real time suggestions for the consumer user for supplier users who may be of interest to the consumer user.

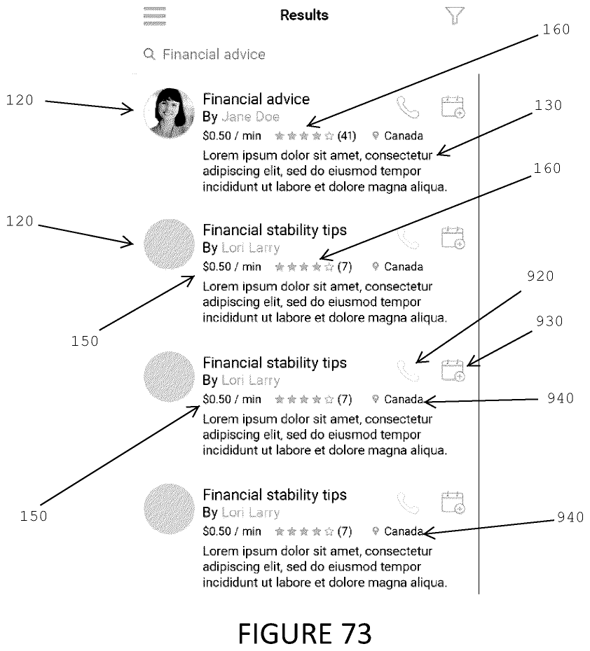

Referring to FIG. 73, a search results screen is illustrated. As can be seen, the search results screen is an alternative to the search results screen provided in FIG. 3. Similar to the screen in FIG. 3, the search results page in FIG. 73 has each supplier user's picture 120, each supplier user's qualifications 130, each supplier user's billing rate 150, and each supplier user's feedback rating 160. However, in addition to the above, the search result screen provides each supplier user's location 940. For the convenience of the user, each search result supplier user can be quickly contacted for a live call using the phone icon 920 or, alternatively, the user can quickly schedule an interaction with the supplier user using the calendar icon 930.

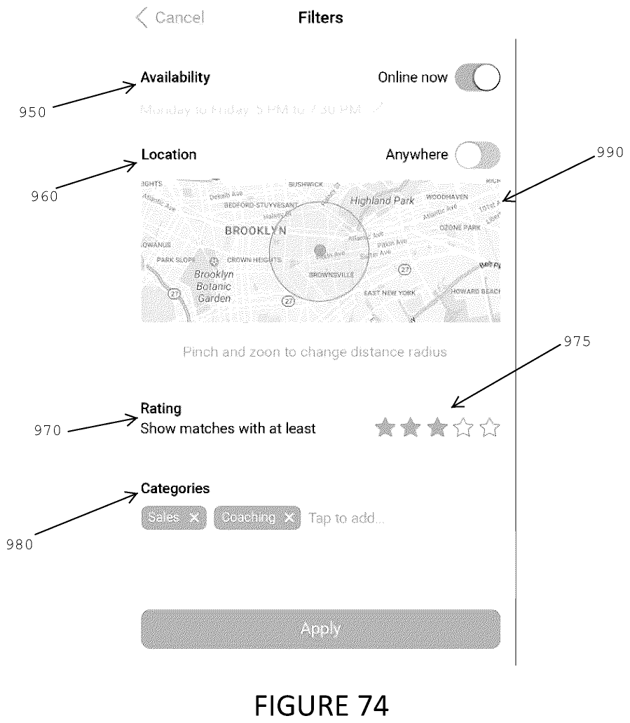

While the search results in FIG. 3 can be reordered based on a number of user preferences, in another implementation, the search results can be filtered based on a number of options, each of which may be activated/deactivated. The screen for these possible options is shown in FIG. 74. As can be seen, the search results can be filtered by availability 950 (e.g. whether the supplier user is immediately available for an interaction), location 960 (e.g. with the user being able to filter by the supplier user's distance from the user), rating 970 (e.g. a supplier user must have a minimum given rating 975 to be presented in the search results), and categories 980 (e.g. the supplier user must have expertise in at least the given fields). When the location filter is active, the user can set the maximum distance between the supplier user and the user by, as an example, pinch zooming on a map 990 with the map being centered on the user's current location.

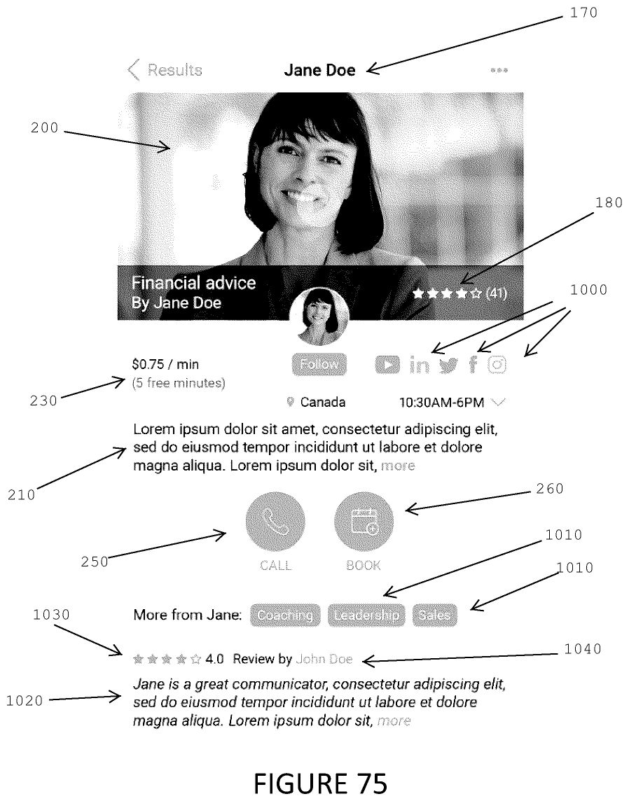

Referring to FIG. 75, a supplier user profile is illustrated. This alternative implementation of the profile is in contrast to the supplier profile illustrated in FIG. 4. The supplier profile in FIG. 75 has the supplier user's name 175, the supplier user's rating 180, the supplier user's photo 200, a description of the supplier user 210, the supplier user's billing rate 230 (including how many free minutes are included), and a call button 250 and a calendar/booking button 260. As with the profile in FIG. 4, the call button 250 allows the user to immediately try to connect with the supplier user while the calendar/booking button 260 allows the user to book an interaction with the supplier user. However, in addition to these elements, the profile in FIG. 75 also provides links 1000 to the supplier user's social media presence. As shown, the links 1000 are to the supplier user's LinkedIn™ page, Twitter™ feed, Facebook™ page, and Instagram™ feed. Also provided are indications or tags 1010 to the supplier user's other fields of expertise. Finally, a user review 1020 is shown along with that user's rating 1030 for the supplier user. To provide credence to the user review, the user providing the review is identified 1040.

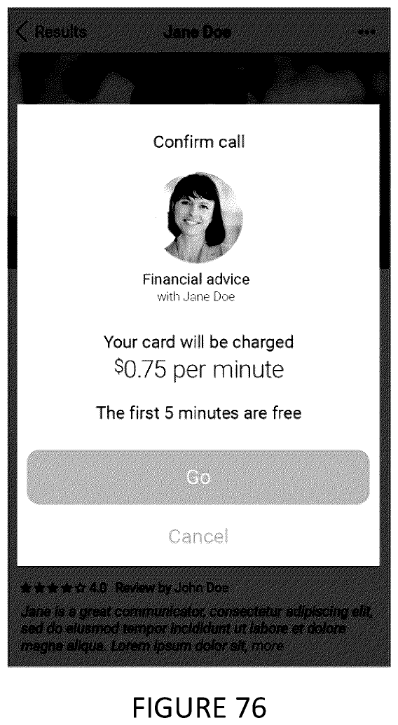

Should the user desire to contact the supplier user for an immediate call, the screen shown in FIG. 76 is shown. FIG. 76 shows that the parameters of the call are being confirmed, including the supplier user being contacted, the by-the-minute billing rate (and any free minutes), and that the user's registered card will be charged that billing rate. The user can confirm the details by clicking on the GO button. This will launch the module necessary to initiate and connect the call.

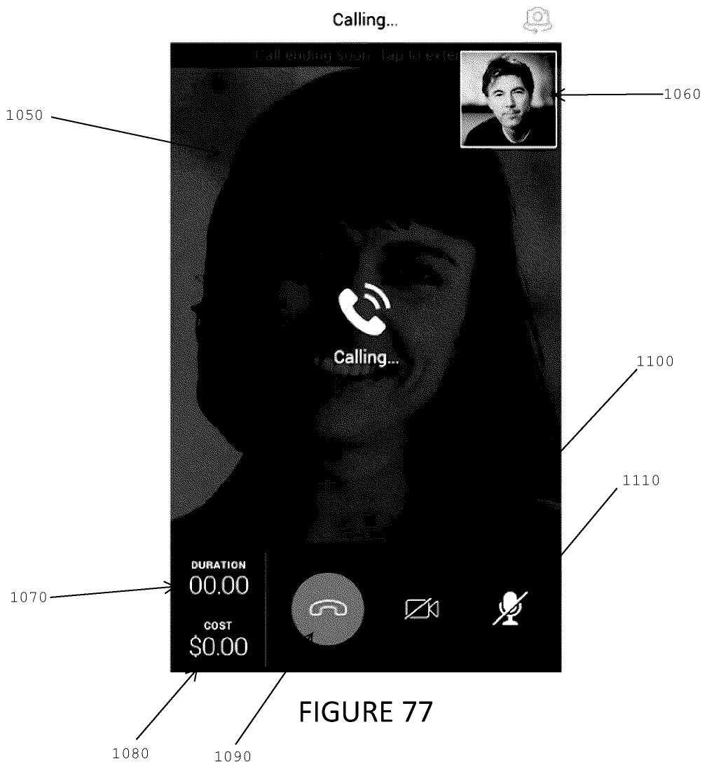

Once a call from the user to the supplier user is initiated, the user's screen will be that shown in FIG. 77. The supplier user's photo 1050 becomes the background to show the user who is being called and the user's photo 1060 is shown in a thumbnail at a corner of the screen. To track the duration of the call, a timer 1070 is provided at another corner while the cost tracker 1080 is also provided. To end the call, a phone icon 1090 is provided while turning off the camera is possible (if a video call) using the camera icon 1100. To mute the call, a mute button 1110 is provided.

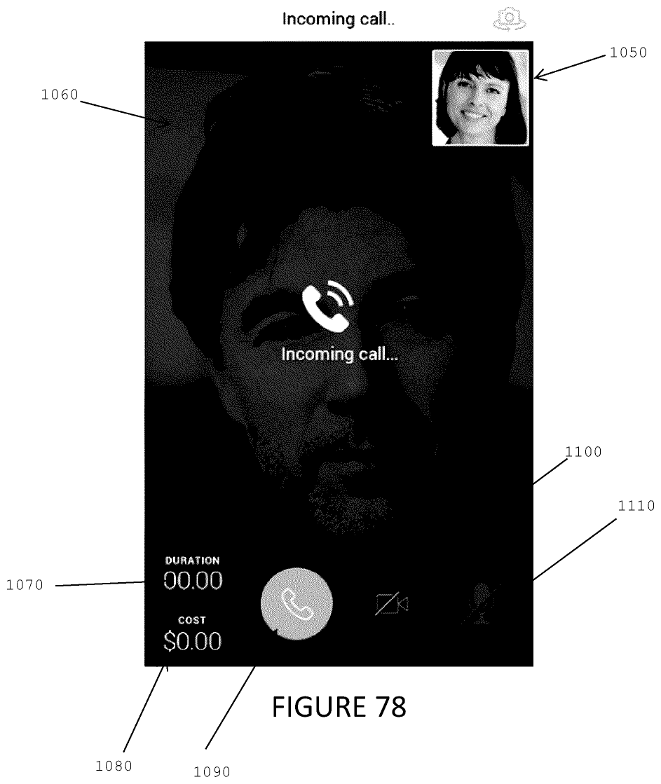

In FIG. 78, the supplier user's device has an interface similar to that of the user when a call is incoming. The incoming call causes the user's photo 1060 to be the background for the supplier user's device while the supplier user's photo 1050 is in a thumbnail in the corner. Similar to the user interface for a call, a time tracker 1070 is provided along with a cost tracker 1080. To answer the call, the supplier user has to activate the phone icon 1090 and, much like in FIG. 77, a camera icon 1100 and a mute button 1110 are provided.

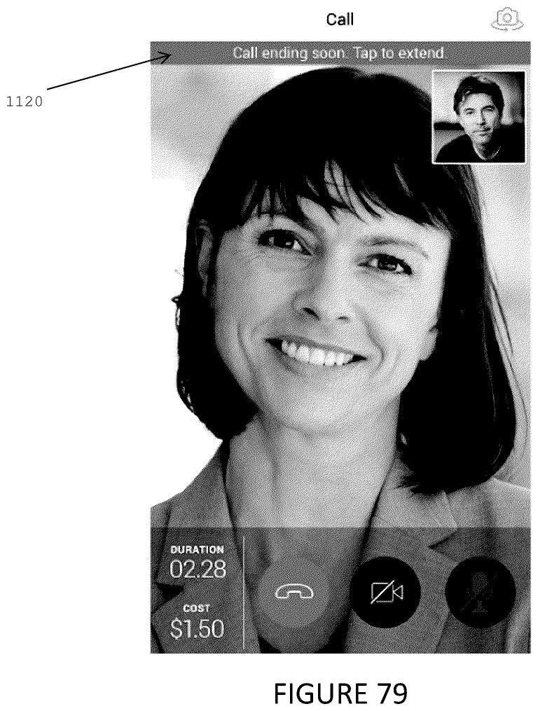

For an on-going call, the user is provided with the interface shown in FIG. 79. The elements in the interface are similar to those in FIG. 77. However, if the user has only purchased a set amount of time for the call, a reminder 1120 is shown to the user when the time for the call is about to run out. This reminder also provides the user with the option to extend the duration of the call to be past the amount the user has already paid for. Of course, the user would be billed for the extra time of the call.

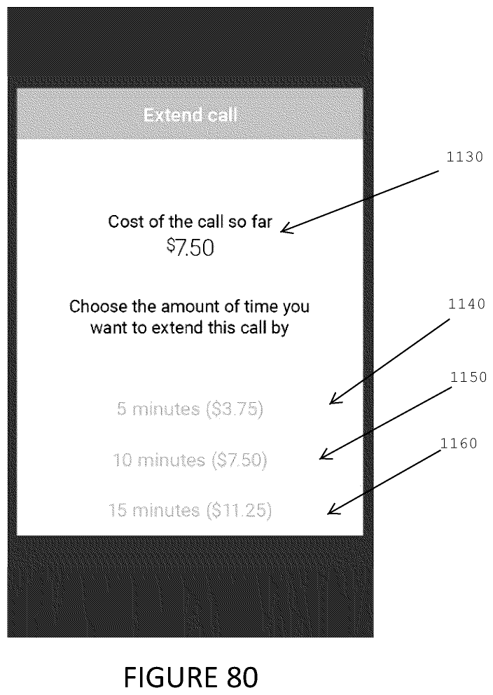

As a follow-on to the interface in FIG. 79, should the user wish to extend the duration of the call, the interface in FIG. 80 is shown to the user. As can be seen, the interface reminds the user of the current cost of the call (element 1130). As well, the interface provides multiple set options for extending the duration of the call. In this example, five minute increments are provided for extending the duration of the call. In the first option 1140, a five minute extension is offered while the second option 1150 offers a 10 minute extension. The third option 1160 extends the duration by 15 minutes. As can be seen, the various amounts for the extension are simply fixed multiples of the first option. Other options, including using a sliding scale to provide the user with discounts for longer extensions of time, may also be used.

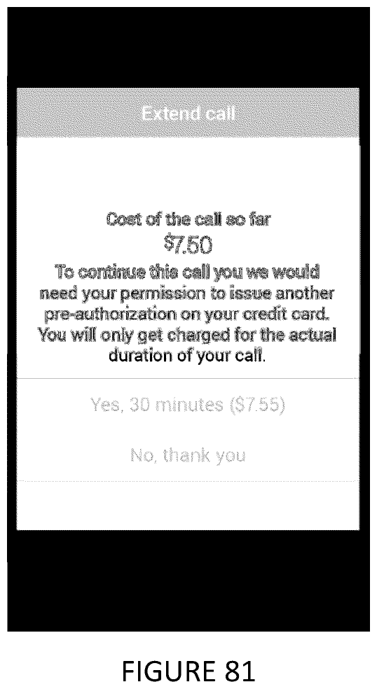

Once the user has selected an option for an extended duration for the call, the user is presented with the interface in FIG. 81. The interface confirms the user's selection for the extended duration of the call and confirms that the user's card will be charged. As well, the interface confirms the length of the extended duration and the amount for the extended duration. As noted above, a discount may be applied to the billing rate should the user select a longer duration. This is evident from FIG. 81 as the charge for an extra 30 minutes is only $7.55 while, from FIG. 80, an extra 15 minutes would have cost an extra $11.25.

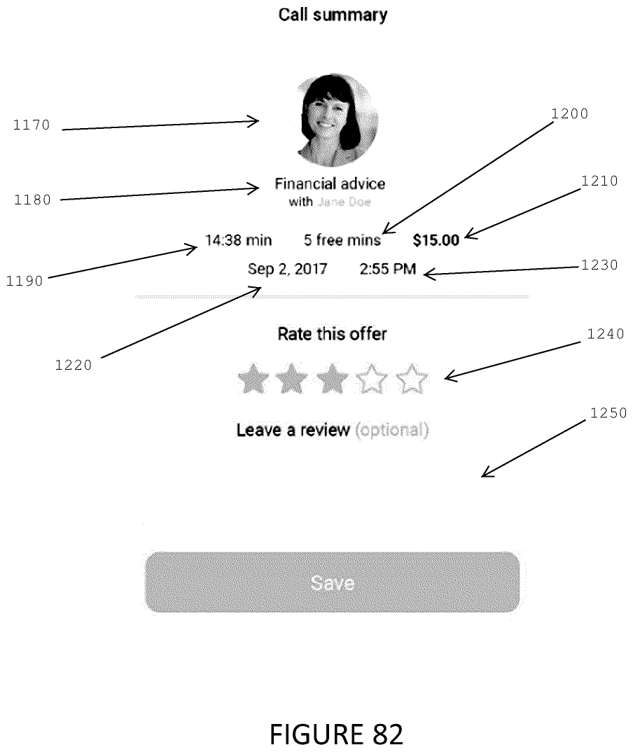

Once the call has been completed, the user is presented with a call summary screen (see FIG. 82). In this screen, the supplier user's picture 1170 is given along with the supplier user's name and expertise 1180. The length of the call is also give (element 1190) along with how many of those minutes were free (element 1200). The total cost for the call is also given (element 1210). The date 1220 and the time 1230 for the call are also provided. The user is also given the chance 1240 to rate the call and the supplier user. In addition, a space 1250 is given for the user to leave comments about the supplier user or the call.

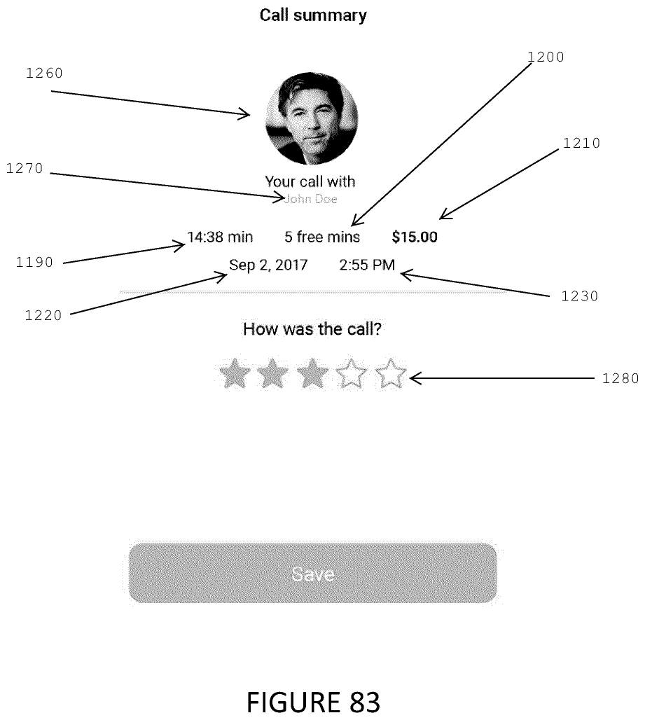

For the supplier user, once a call has been completed, the screen in FIG. 83 is presented. For this call summary screen, the user's picture 1260 and the user's name 1270 are given. Much like the call summary screen in FIG. 82, the call summary screen for supplier users details the duration of the call 1190, the amount of free minutes 1200, the total cost of the call 1210, as well as the date 1220 and time 1230 of the call. However, in contrast to the summary screen in FIG. 82, the supplier user can only rate 1280 the call and cannot provide free form comments about the user or the call.

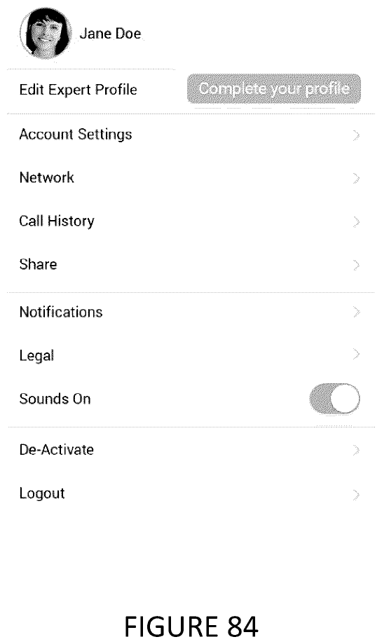

For the supplier user, the creation and/or editing of his/her profile is important as the profile is presented to other users. A well-written and well-presented profile can be the difference between receiving numerous requests for calls and not receiving any. To this end, each supplier user can edit his/her account from a menu as shown in FIG. 84. As can be seen, the supplier user can view/edit his profile, view/edit account settings, view/edit network settings, view his call history, and view/edit his sharing settings. Similarly, notification settings can be edited and any legal disclaimers can be viewed from this screen as well. The supplier user can also turn on/off any sounds for his account as well as deactivate the account as a whole. And, finally, the supplier user can logout from his account from this screen.

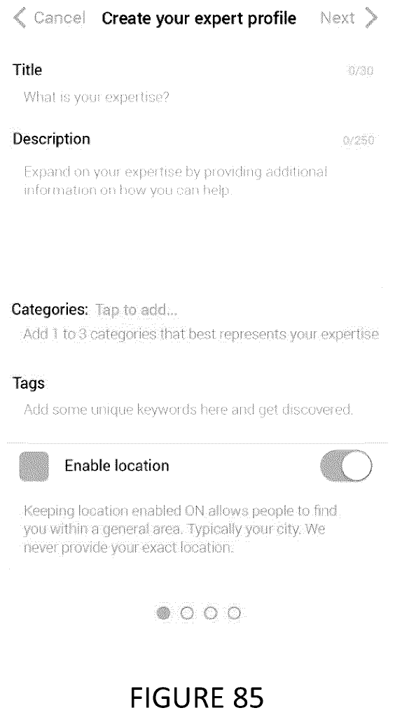

To create a supplier user profile, the potential supplier user has to complete a profile. To this end, the interface in FIG. 85 provides a template for the various components of the supplier user's profile. This interface combines the functions of the different screens illustrated in FIGS. 25-28. In addition, this interface allows the supplier user to activate location tracking so that the system can determine the supplier user's location.

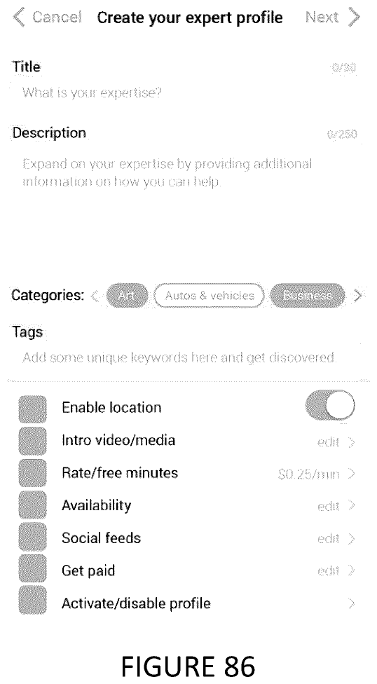

Once a supplier user's account has been created, the supplier user can use the interface presented in FIG. 86 to adjust/amend his account as necessary. As can be seen, the interface allows the supplier user to edit/create his profile as necessary, enable/disable location tracking, edit/create an introductory video, adjust the billing rate and any free minutes available, change the supplier user's schedule of availability, change his social feeds, change the parameters for his bank/credit cards, and activate/deactivate his profile.

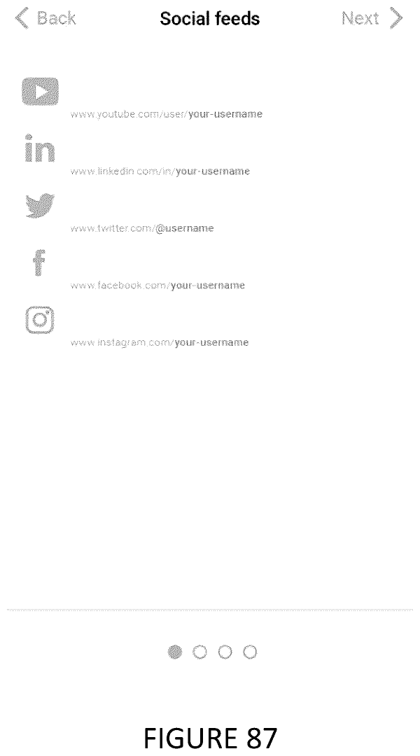

Should the supplier user wish to change the parameters for his social media presence, FIG. 87 shows the screen where this can be done. In FIG. 87, the supplier user can detail his YouTube™ account, his LinkedIn™ account/profile, his Twitter™ account, his Facebook™ profile, and his Instagram™ feed. Of course, other accounts to other social media feeds and profiles may be added if necessary. Note that this interface is in contrast to the interface provided in FIG. 29.

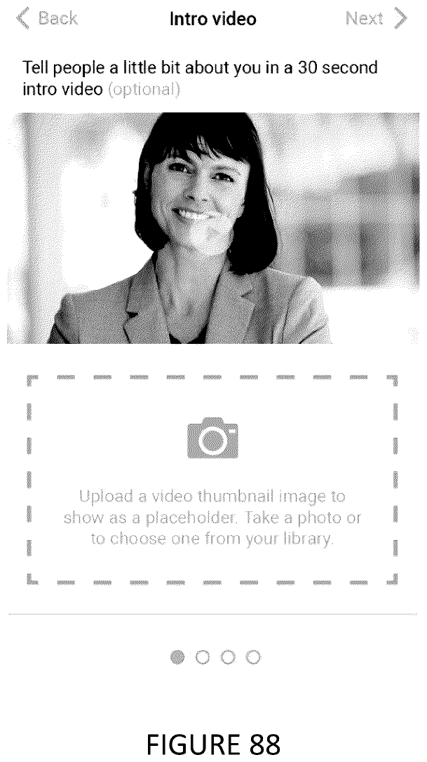

Should the supplier user wish to add an introductory video for users to view, FIG. 88 shows the interface for adding a video. The interface in FIG. 88 combines the functions of the interfaces shown in FIGS. 30-31.

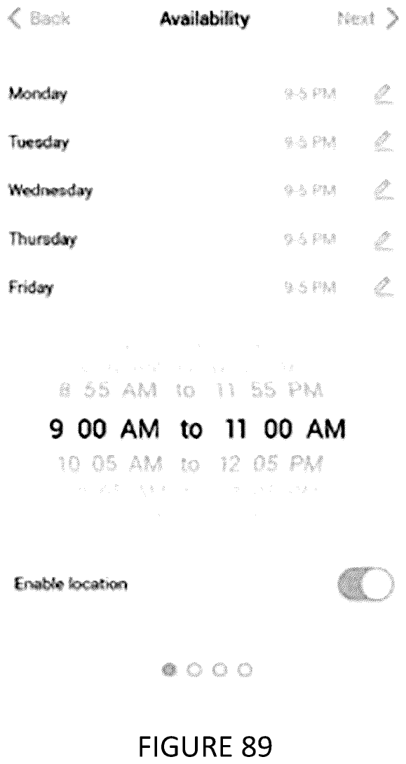

A supplier user's availability can also be adjusted using the interface in FIG. 89. This interface is in contrast to the interface shown in FIG. 36. While the functions of these two interfaces are similar, the interface in FIG. 89 may be easier to use and includes the ability to activate/deactivate the location function.

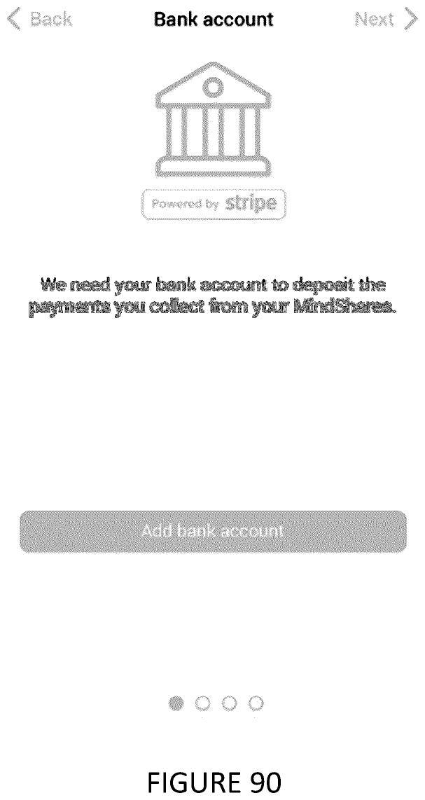

Referring to FIG. 90, the supplier user is prompted to provide his/her bank account information so that the supplier user may be paid. As can be seen, this interface is very similar to the interface provided in FIG. 37, with the main difference that the interface in FIG. 90 indicates service provider that handles the details of any bank transfers or banking transactions.

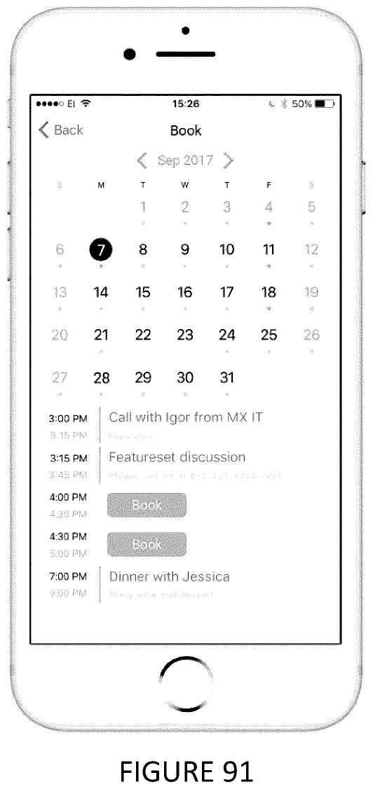

As noted above, a user's calendar on the mobile device can be integrated with the system. This allows the system to determine open slots for booking interactions with supplier users as the system, in the background, checks both the relevant supplier user's calendar and the user's calendar. To illustrated this, FIG. 91 shows a user's calendar with openings for both 4 pm and 430 pm. Since these slots are open for both the supplier user and the user, the user is prompted to book these slots with the supplier user.

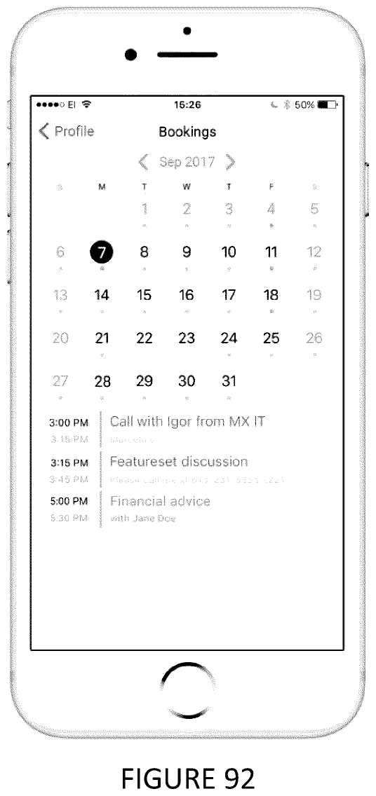

Once a user has booked an interaction with a supplier user, the booked appointment appears on the user's calendar, as shown in FIG. 92.

It should be clear that the booked appointments in the calendar are tied to billing. As such, if a consumer user has booked off a specific block of time with a supplier user, the consumer user is still billed for that booked off time if that consumer user does not keep the appointment (i.e. does not follow through with the scheduled interaction with the supplier user). Note that methods for mitigating this issue may be implemented if desired. As an example, if the consumer user cancels the appointment within a predetermined amount of time before the appointment (e.g. 2 hours before the appointment), the consumer user may not be charged the time booked off or a small booking cancellation fee may be charged instead of the whole amount of time booked off. Similarly, a case-by-case dispute mechanism may be used such that, if the consumer user provides a suitable excuse for the absence, the affected supplier user has the option to not charge the full amount. Similar systems for a consumer user's tardiness for a booked appointment may also be used. For example, the tardy consumer user may be charged the amount of time by which he was late. Similarly, if a supplier user is late or is unable to be there for a scheduled appointment, the consumer user would not be charged for the amount of time that the supplier user was not present on the call/interactions.

As another feature of the system, the calendar system would also check and ensure that each user's time slot is not double booked, i.e. have appointments that overlap or appointments in the same time slot on the same day.

As noted above, the supplier user may also provide specific time ranges and specific days for which he is available for bookings or appointments. With this feature, supplier users do not have to manage their calendars as much as it would be the consumer user's responsibility to ensure that the desired appointment conforms to the supplier user's availability. In addition to booking off availability, the supplier user can also block off time ranges or days during which the supplier user is unavailable. As such, during those time ranges, the supplier user is simply unavailable and calls, text messages, and push notifications would not be put through to the supplier user.

As another variant to the calendar feature, multiple supplier users can share their calendars with other supplier users. This would allow teams of supplier users with specific fields of expertise to coordinate their availability. Thus, in a corporate environment (as noted above), it can be ensured that someone is always available to answer queries from consumer users.

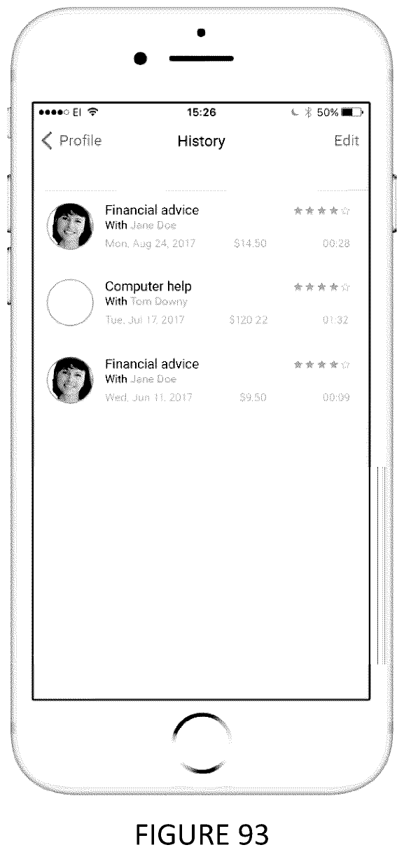

To assist the user in managing his use of the system, a history interface as shown in FIG. 93 may be used. In this interface, the user's interactions with supplier users are detailed. As can be seen, each supplier user that the user has interacted with is detailed, along with the date of the interaction, the total cost for that interaction, and the duration for the interaction. It should be clear that a user's interactions in the history interface are arranged in chronological order so that multiple interactions with a specific supplier user will be evidenced by multiple appearances of that specific supplier user in the history.

It should also be clear that, while the user interface illustrated in FIG. 93 details the most recent interactions for a user, the system may be configured to store and record every action performed by a user on the system. Such actions recorded may include viewing a supplier user's public profile, adding and/or deleting oneself as a follower of a specific supplier user, entering and/or deleting appointments, any changes to search preferences, any changes to public and/or public profiles, any changes to search result preferences, blocking/unblocking other users, participating in any messages/conversations with other users, adding a rating and/or feedback to any user, flagging any inappropriate content, and any financial transactions transacted through the system. Depending on the configuration of the system, only the most important (and potentially relevant) actions are viewable by each user. However, a variant would allow each user to view any and all actions/interactions that user has had with the system. For such a variant, the history would be searchable and would allow the user to find not just his actions but also who or what the action related to.

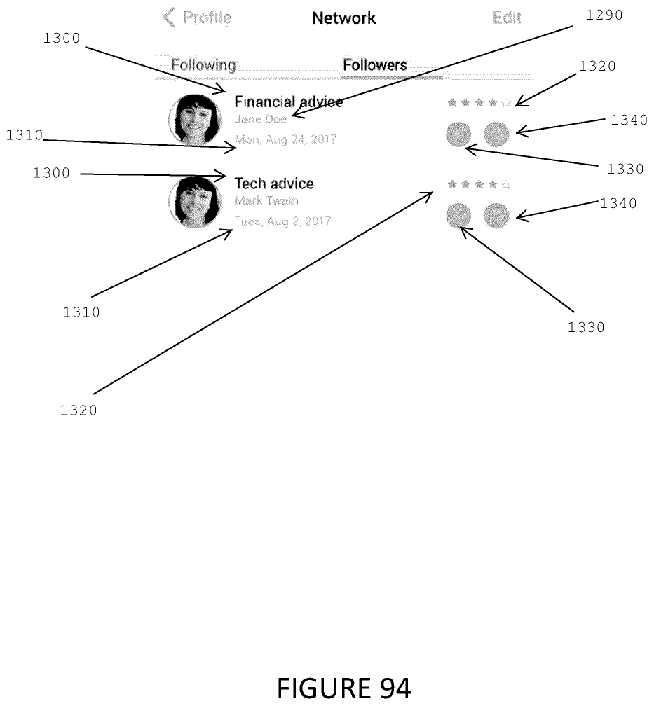

To keep track of the supplier users that a specific user has interacted with, an interface detailing a user's network, such as that in FIG. 94, may be used. As can be seen, the network or contact interface details the names 1290 of the different supplier users the user has interacted with, the field of expertise 1300 for each supplier user, the date 1310 of the last interaction, and the rating 1320 for each supplier user. For ease of access to these supplier users, a phone icon 1330 and a calendar icon 1340 are provided for each supplier user. This allows the user to immediately call the relevant supplier user using the phone icon 1330 or to book an appointment using the calendar icon 1340. It should be clear that this interface is in contrast to the network or contact interface presented in FIG. 8.

Regarding implementation, the system of the present invention may be implemented as a number of software modules. These modules may be implemented on one or more servers connected to the Internet so as to service multiple users and supplier users. Alternatively, the system may be implemented using a cloud based computing platform using similar modules. In one implementation, a distributed system is used that allows for the deployment of servers based on need in any geographic area. Thus, for this implementation, there is no requirement for a master server such that even if one server goes down, other servers can compensate.

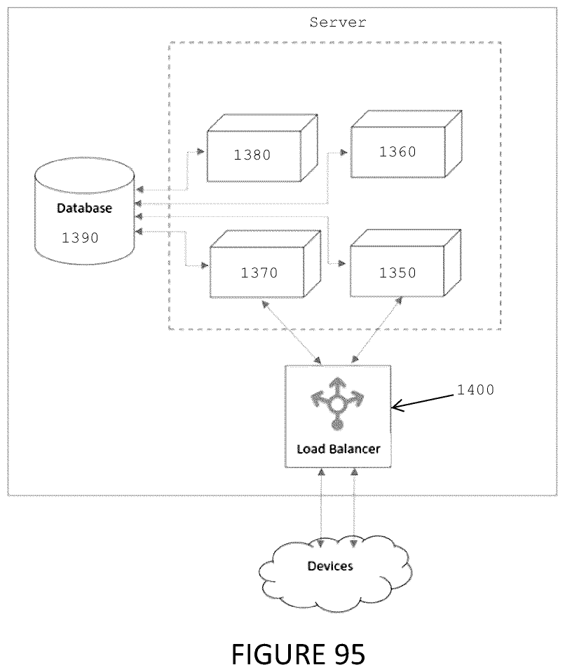

Regarding these modules, in one implementation, schematically illustrated in FIG. 95, a main module 1350 is present along with a communications module 1360, a background module 1370, and a maintenance module 1380.

The main module 1350 handles user input/intake, fetching users, creating conversations between users (including between supplier user and regular users), new accounts, and most of the other processing requests for the system.

The communications module 1360 is responsible for maintaining network connections with users for telephone/video sessions while the sessions are on-going. The module 1360 allows for updates in the conversations (e.g. text only conversations) to be sent back and forth between the participants. Each user device (whether used by a supplier user or a regular user) usually will need to sign into a user-specific channel to receive notifications over the network communications channel. For ease of use, the module also ensures that the user, while connected to the communications channel is marked as being “online”.

The background module 1370 deals with jobs or tasks that are handled in the background, especially regularly scheduled tasks. As examples, the background module handles the calculation of rating summaries, the invalidation of caches, and the calculation of graph data for the different dashboards.

The maintenance module 1380 deals with tasks triggered by other modules. Examples of such tasks include the sending of emails, handling of payments, summary reviews, and upgrading of supplier user tiers.

In addition to the above modules, the system uses a database 1390 that stores the various data required for the different users and supplier users. As can be imagined, the database is accessed by the various modules as required. In one implementation, PostgreSQL is used to implement the database. In this implementation, sharding is used to ensure real-time interactions for the various users. The database may be partitioned so that other certain cached data lives on every instance. This allows for data sharing such that if any data is needed by a parallel database, that data can be requested and sent on a need-to-know basis in order to prevent severe memory duplication.

To ensure that the system is not bogged down by too many requests for specific resources from the users and supplier users using the system, a load balancer 1400 may be deployed between the user devices and the various modules. The load balancer ensures that the requests from the various user devices are dealt with and are distributed properly between the various modules. Of course, the system may use multiple instances of the various modules to ensure that the user device requests are properly handled. To this end, the load balancer may also be used to balance the processing loads across the various instances of the various modules.

It should be clear that some enhancements to the system may be implemented to ensure a more fair and useful experience for both consumer and supplier users. As an example, for the feedback and ratings system, each rating from a consumer user can be handled individually or, for a more fair result, if a single consumer user leaves multiple ratings for a specific supplier user, these multiple ratings are averaged and only the average rating counts towards the overall rating average for that specific supplier user. As well, supplier users can have the option of hiding reviews from specific consumer users. However, the ratings from these consumer users will still count towards the supplier user's overall aggregate/average ratings. This ensures that bad reviews can be hidden but bad ratings cannot.

Also, much like other social media sites and/or applications, users can choose to block other specific users, whether they be consumer users or supplier users. Blocking a user may prevent blocked users from communicating with blocking users—calls cannot be initiated, conversations cannot be started, and posts or reviews cannot be entered. Such measures can assist in ensuring a free and fair community of users.

As noted above, consumer users can search for supplier users with expertise in specific topics or fields. The search can be a free form search where the consumer user enters search terms and/or search concepts. The system can perform searches for matches to all of the search terms or to specific search elements (e.g. elements within delimiters such as brackets or quotation marks) or to elements within aggregate search terms. As an example, a consumer user can search for experts in “carburetor compression pressure”. The system can initiate a search for supplier users whose profile contains all of the search terms as an aggregate or it can also initiate a search for the individual search elements (i.e. a search for “carburetor”, a search for “compression”, and a search for “pressure”).

It should be clear from the above description that the system may be implemented using different methods and schemes. In one implementation, a single model is used to store all users, regardless of whether a user is a consumer user or a supplier user. As well, in this implementation, each user has a private and a public profile. For this implementation, all of the data entered during registration is stored in the various fields of a database entry and may include data points such as a user's schooling, resume, experience, etc., in addition to the other data points requested during registration. For this model, data that is considered as an array (e.g. keywords, followers, descriptions in multiple languages, credit cards) and not as fields (e.g. names, specialties, etc.) is stored in its own model and is associated with the specific user. Thus, for this implementation, a keyword search would be performed on the keyword model. Of course, a keyword search may also be performed on the other data associated with each user (e.g. username, name, specialties, description, etc.) to ensure proper coverage for the search. For such an implementation, each field in the user model is also marked either public or private to ensure that no private information is displayed or given away without permission. This mechanism may be used to differentiate between consumer users and supplier users and may also be used to determine which data is publicly available and which data is only viewable by the owner of the profile/model.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A system for facilitating online interactions between at least one consumer user and at least one supplier user, the system comprising:
at least one server comprising:
a supplier database, said supplier database containing a plurality of supplier user profiles for a plurality of supplier users, each of said supplier user profiles detailing at least one specific expertise of a specific supplier user, and a plurality of expertise keywords relating to said at least one specific expertise;
a plurality of communications modules, each of said plurality of communications modules being for facilitating direct online communications between said at least one consumer user and one of said plurality of supplier users;
and
at least one processor for:
receiving a query from said at least one consumer user;
determining, based on said query, query keywords for expertise relating to said query;
searching said database for at least one supplier user whose at least one specific expertise relates to said query keywords;
retrieving supplier user profiles based on said query for said at least one supplier user profile whose at least one specific expertise relates to said query keywords;
presenting supplier user profiles retrieved based on said query, said supplier user profiles retrieved being presented to said at least one consumer user;
receiving input from said at least one consumer user selecting one of said supplier user profiles presented, said input indicating a selected supplier user;
activating at least one of said plurality of communications modules to send and receive data from said selected supplier user and sending data received from said selected supplier user to said at least one consumer user to thereby allow for an interaction between said selected supplier user and said at least one consumer user;
deactivating said at least one of said plurality of communications modules when said interaction is terminated; and
determining a duration for said interaction,
wherein said at least one processor is further for simultaneously and automatically presenting multiple supplier user profiles to said at least one consumer user, and
wherein at least one specific expertise of a first one of said multiple supplier user profiles differs from at least one specific expertise of a second one of said multiple supplier user profiles.

2. The system according to claim 1, wherein said plurality of communications modules is for at least one of:
audio communications;
video conferencing;
video communications;
allowing said consumer user to view a screen of said selected supplier user;
a network based video seminar; and
text communications.

3. The system according to claim 1, wherein said system further comprises a backup module for backing up said database.

4. The system according to claim 1, further including a consumer database containing consumer user profiles.

5. The system according to claim 1, wherein said duration is only determined for real-time or near real-time interactions.

6. The system according to claim 1, wherein said processor is further for timing how long said interaction between said at least one consumer user and said selected supplier user occurs.

7. A system for online interactions between users, the system comprising:
a server;
a database containing profiles;
a processor;
wherein
said system receives a query from a consumer user;
based on said query, said processor searches said database for at least one profile relating to said query;
said system activates at least one communications module such that said consumer user and a supplier user represented by said at least one profile are in online communication with each other to discuss said query; and
said system determines a duration for an interaction between said consumer user and said supplier user using said at least one communications module,
and wherein said system simultaneously and automatically presents a plurality of profiles to said consumer user.

8. The system according to claim 7, wherein said plurality of profiles is related to an interaction history of said consumer user.

9. The system according to claim 7, wherein said system activates said at least one communications module to send and receive data from said supplier user and sends data received from said supplier user to said consumer user.

10. The system according to claim 7, further comprising a calculation module for use with said duration of said interaction.

11. The system according to claim 7, wherein said at least one communications module is for at least one of:
audio communications;
video conferencing;
video communications;
allowing said consumer user to view a screen of said supplier user;
a network based video seminar; and
text communications.

12. A method for facilitating online interactions between users, the method comprising:
a) simultaneously and automatically presenting a plurality of supplier user profiles to a consumer user, each of said supplier user profiles detailing at least one specific expertise of a specific supplier user;
b) receiving an indication of a selected supplier user, said selected supplier user being selected from said plurality of supplier user profiles;
c) receiving a request from said consumer user for interaction with said selected supplier user; and
d) activating at least one communications module to allow said consumer user to communicate and interact with said selected supplier user.

13. The method according to claim 12, wherein a first one of said plurality of supplier user profiles has a specific expertise that is different from an expertise of a second one of said plurality of supplier user profiles.

14. The method according to claim 12, wherein said plurality of supplier user profiles is based on an interaction history of said consumer user.

15-19. (canceled)
